(19) United States
(12) Patent Application Publication
(10) Pub. No.: US 2011/0093295 A1
(43) Pub. Date: Apr. 21, 2011

(54) CONSUMER ENABLING SYSTEM FOR PERSONALIZED HEALTH MAINTENANCE

(76) Inventors: Vipul N. Mankad, Oakland, CA (US); Saswata Mukherjee, Moraga, CA (US)

(21) Appl. No.: 12/884,283

(22) Filed: Sep. 17, 2010

Related U.S. Application Data
(60) Provisional application No. 61/277,004, filed on Sep. 19, 2009.

(51) Int. Cl. G06Q 50/00; G06Q 90/00; G06Q 10/00

(52) U.S. Cl. 705/3; 705/500

(57) ABSTRACT

We disclose a system (human interaction, process, software and a device) that analyzes health maintenance options emanating from expert panels in relationship to age, race/ethnicity and gender, family history and genetic susceptibility, lifestyle as well as historical information entered by the consumer, develops a personalized health maintenance plan and assists the consumer in implementing such a plan. The system allows a consumer, not necessarily a health professional, to develop a personalized plan that would otherwise require complex analysis and medical training. The system is automated and updatable, capable of learning from experience and allows potential interface with Electronic Medical Records.

### CROSS-REFERENCE TO RELATED APPLICATIONS

This application claims the benefit of Provisional Patent Application No. 61/277,004 filed on Sep. 19, 2009 by present inventors.

### FEDERALLY SPONSORED RESEARCH

Not Applicable

### SEQUENCE LISTING OR PROGRAM

Not applicable

### BACKGROUND OF THE INVENTION

1. Field of Invention

This application discloses an automated system for assisting and enabling the consumer of health care to develop a personalized health maintenance plan appropriate for his or her age, race/ethnicity and gender, family history, lifestyle as well as selected historical data using analytical methods used by multiple medical disciplines and knowledge gained and synthesized from large number of experts and professional organizations.

2. Prior Art

### Background:

Historically, individual consumers often referred to as “patients” by health care professionals, have been regarded pejoratively as subordinate, passive recipients of physician-initiated care. They are expected to visit offices of primary care providers (family practitioners, general pediatricians, general internists, nurse practitioners or others) to seek advice about their health maintenance. The advice must be personalized for their age, race/ethnicity, gender, lifestyle and historical information such as past history, family history, personal/social history, geographic location and in some cases, previously performed laboratory tests such as cholesterol levels or screening tests for genetic susceptibility to certain diseases such as cancer or heart diseases. Although health care providers formulate their recommendations based on knowledge acquired during their long training and continuing education, there are many deficiencies and shortcomings in this system.

(1) Despite best intentions, individual primary care providers may be deficient in their knowledge of preventive health maintenance. Recommendations for health maintenance emanate from large number of expert panels (e.g. American Medical Association, American College of Physicians, American Academy of Pediatrics, American Academy of Family Physicians, American College of Surgeons, large number of professional societies and groups devoted to Cancer, Heart Disease, Stroke, Diabetes, Infectious Diseases, and Neurological Diseases, and U.S. Preventive Services Task Force (USPSTF), as well as governmental agencies such as 27 institutes and centers within the National Institutes of Health (NIH), Centers for Disease Control and Prevention (CDC), Centers for Medicare and Medicaid Services (CMS), Agency for Healthcare Research and Quality, (AHRQ), Food and Drug Administration (FDA) and others. A busy physician may not have the time to review all of the recently published information from the “alphabet soup” of agencies and organizations. The system disclosed here is based on the premise that a well-informed consumer will be able to assume greater responsibility for his or her own care, partner with the health care provider and use the healthcare system more efficiently.

(2) To assist primary care clinicians in applying preventive care guidelines, AHRQ, through its expert panel USPSTF, has prepared tools downloadable to the Internet or PDA devices. These tools, available in the public domain, allow clinicians to enter the patient's age, gender, smoking history and sexual activity status but not family history, an extremely important component in personalizing care. The AHRQ tool provides recommendations classified into three categories; recommended, not recommended and uncertain. Then, the tool provides USPSTF'S interpretation of published evidence, factors that clinician should consider, rationale and complex risk-benefit analysis. Recommendations are graded A, B, C, D and I (for insufficient) based on published evidence. However, the recommended and uncertain lists and supporting documents are complex, lengthy and time consuming. They are also generic, based on few selected criteria (patient's age, gender, smoking history and sexual activity status) about the patient. Without family history to determine genetic susceptibility and other personal attributes such as height, weight, BMI, and so on, it is not possible for a clinician to use the tool to personalize the plan for a specific patient. Thus, counseling a patient would still require considerable amount of time and judgment by the clinician to develop a specific and personalized health maintenance plan for a patient. As a panel appointed by a government agency, the USPSTF takes into account national healthcare expenditure. The panel makes judgments about various screening tests based on costs of detecting sufficient number of patients with a specific diagnosis to justify national expenditure. For example, USPSTF advises against mammography for women between ages 40 and 50 years because in the judgment of the AHRQ panel, national costs could not be justified for the estimated number of women with early breast cancer detectable in that age group.

However, the American College of Surgeons, American Cancer Society and Susan B Komen Foundation (a breast cancer advocacy group) disagree strongly with the USPSTF panel, based on their advocacy of individual patient's interests. Considering relatively low cost of mammography, an individual patient in the 40-50 years age range, if properly informed, may indeed choose to have the test. This would be particularly important if the individual was in the high-risk category because of family history and/or race/ethnicity. Moreover, the USPSTF (AHRQ) tools or NIH websites were not developed for consumers without medical background and do not achieve the objective of empowering helping the consumers to take greater responsibility for their own care and making informed choices.

(3) Recommendations from various groups are conflicting in some aspects, written in technical language and not customized to circumstances of an individual patient or interpretable by a non-clinician. Some recommendations may be written in such a way that a physician's judgment is required even for simple tasks and therefore, a consumer is unable to take action on such a recommendation. For example, discussion for breast cancer screening by the National Cancer Institute (NCI) states that physically inactive and obese patients are at higher risk of breast cancer. However, the NCI recommendation does not define obesity and leaves it to the judgment of the physician. An embodiment of the present system will calculate the Body Mass Index (BMI) from data provided, determine the obesity related risks for the individual and make recommendation tailored to that individual. Relatively simple, self-help tools for calorie counting, nutrition and physical exercise are now available on the Internet. However, voluminous and complex recommendations for health maintenance from large numbers of medical and scientific groups have not been synthesized, automated, and made available to consumers in non-technical language and customized to individual needs.

(4) Shortage of primary care providers presents problems of access to such information, though inadequate as mentioned above, even for individuals with health insurance. In addition, more than 44 million Americans, who do not have health insurance, have even greater difficulty in accessing primary care and often seek their care for acute problems in the emergency rooms ill equipped to prepare personalized health maintenance plans. Thus, people suffer from preventable diseases causing needless suffering and increased costs for themselves and the country as a whole. Even if healthcare reform through the Patient Protection and Affordable Care Act results in increased health insurance coverage, it will not change availability of primary care providers and high quality health maintenance information for consumers in the near future.

(5) Time available to a typical primary care provider is often less than 15 minutes for each patient, during which a detailed history and physical examination must be completed, recommendations formulated and discussed, and patient's understanding of the recommendations evaluated. This makes it quite likely that health maintenance plan will be incomplete or deficient. Consequently, as mentioned above, preventable diseases have occurred with increasing frequency and added to significant societal costs of health care in addition to causing needless disability. If consumers of health care are enabled and empowered with information, they can not only take initiatives for their own preventive care but also, partner with health care providers and utilize the health care system more efficiently.

(6) Efforts to inform consumers about preventive health care and management of various diseases have received increased attention during the last decade but not resulted in appropriate personalized tools. Voluminous information is available through web pages of health plans, hospitals, employers' wellness plans, government agencies such as CMS, CDC, AHRQ and NIH, and general health information web sites. It is like asking a thirsty individual to go to the fire hydrant rather than presenting a glass of water. Although wealth of information about various diseases, wellness and nutrition is available on the Internet, individuals have to read large number of sites, integrate the information, often written in technical language, and have analytical abilities similar to well trained physicians to synthesize the information, apply it to their own circumstances and develop health maintenance plans. Through portable, Internet-enabled devices such as Personal Digital Assistants (PDA) and SmartPhones, one can access the information available on the Internet. However, comprehensive but personalized approaches tailored to individuals based on their age, sex and race, and carefully selected historical facts are not available on the Internet.

(7) The Internet tools available to physicians or consumers do not adequately integrate benefits from recent, phenomenal revolution in genetic medicine. After 13 years of historic effort, the human genome was sequenced in 2003, at the tax-payer-cost of $2.7 billion. More than 20,000 genes and 3 billion base pairs of human DNA were sequenced and information stored in public databases (Francis Collins, Language of Life, Harper Collins Publishers, 2010). At the present time, cost of sequencing all genes in an individual is prohibitive. With future advances in sequencing technology, the cost of sequencing the entire genome may come down to $1,000 per person. However, in 2010, it costs between $399 and $2,499 to screen only few selected genes. Therefore, it is prudent to identify those individuals who would benefit from such selective screening. As explained later in the application, an individual with Ashkenazi Jewish ancestry (eastern European background) and a family history of early breast cancer should be examined for presence of breast cancer susceptibility genes (BRCA1 and BRCA2). Also, an individual with either first-degree relatives or a certain pattern of second-degree relatives should be screened for those genes even without Ashkenazi Jewish ancestry. Prostate cancer screening should begin earlier in African Americans than in white Americans. None of the automated tools individualize plans based on combination of racial/ethnic background and family history to select those who would benefit from further genetic screening. This patent application discloses a new process to incorporate the benefits of the Human Genome Project and specific genetic screening based on family history, race and ethnicity and other personal information.

(8) In the absence of personalized health maintenance action plan, consumers or those who assist consumers are not able to create systems such as customized checklists of steps to be taken, follow up of progress in completing the plan, reminders for incomplete or pending actions, encouragement and support. Actions related to health maintenance often remain incomplete, delayed or postponed.

### Search for Prior Art:

To evaluate previous attempts to empower patients in health care by using computerized tools, we conducted extensive search of US and International patents and patent applications at the Patent and Trademark Depository Libraries using the seven steps recommended by the US Patent Office. The search included but was not limited to the US Patent Classification Numbers 705/2, 705/3, 600, 128/920, 128/923, 128/924, 434/236 and International Patent Classification Number G06F019/00. These categories reveal patents or patent applications targeting operational efficiency of the health care system (billing, collections, appointments and patient through-put), information and assistance to physicians and pharmacists, and remote monitoring of chronically ill patients by providers. However, these patents do not describe automated systems empowering consumers with information on health maintenance in non-technical language, enabling them to develop personalized plans and helping them to follow their own progress.

We summarize patents and patent applications describing interaction with healthcare consumers, i.e. patients, by using computerized tools.

U.S. Pat. No. 7,765,113 (2010) by Ware et al discloses a computer-based system for assessing the health status or health care of a patient, which provides an estimated score. The questions are generated by a test generator and answered by a patient with an objective of assessing and monitoring the health status perceived or experienced by the patient, e.g. impact of headaches, physical fitness, emotional fitness, depression, or the impacts of asthma, managed by a clinician or a clinical enterprise. Resultant score may be useful in longitudinally following the change in the patient's condition, e.g. score may increase or decrease indicating improvement or deterioration in the illness. However, the invention does not address consumer education about preventive health care, does not present personalized preventive care plans, and does not assist the consumer, who may not be ill, about initiatives he or she may take to maintain health.

U.S. Pat. No. 7,330,818 (2008) by Ladocsi et al discloses a life expectancy management system, which comprises storage of genetic, birth, lifestyle, pediatric health, and adulthood health data; and a prediction modeling logic, which provides a predetermined life expectancy. However, the outcome of this system is not a personalized health maintenance plan but a prediction of how long a person is going to live. Synthesis of information about disease prevention, application of medical knowledge to personal circumstances of the individual, education of the consumer, development of personalized health maintenance plan, and assistance with implementation of the plan are not addressed in the system.

U.S. Pat. No. 7,076,437 (2006) by Victor Levy discloses a web-based system for facilitating self-diagnosis by an individual (patient) of medical symptoms (e.g. chest pain). Although the invention claims the use of evidence-based clinical algorithms for evaluation of symptoms, the individual user must exercise significant judgment in interpreting his or her own symptom. For example, in case of chest pain, this would involve judgment regarding character, location and severity of pain and associated symptoms and testing of clinical hypotheses to arrive at a self-diagnosis. An acute symptom such as chest pain may be caused by relatively minor conditions such as muscle strain, self-limiting conditions such as indigestion, or serious and potentially fatal heart attack from myocardial infarction. The consumer is usually not able to make objective evaluation of a symptom such as chest pain. This and other computerized systems for self-diagnosis of acute or chronic illnesses use a clinical logic for evaluation of symptoms. The clinical logic in Levy's patent is quite different compared to logic required for development of a preventive health care plan as explained below. Levy's patent does not attempt to address preventive health maintenance for consumers who are asymptomatic.

Similarly, in U.S. Pat. No. 5,594,638 (1997), Edwin Iliff describes a computerized medical diagnostic system, giving medical advice over a telephone network, for 100 common problems and addresses patient complaints, with the intent to reduce dependence on telephone calls to physicians or nurses after hours. Since interpretation of symptoms and signs and analysis of variety of diagnostic hypotheses requires judgment of experienced clinicians, computerized systems for self-diagnosis have significant limitations. Also, similar to Levy et al, the Ilif patent does not addresses preventive care and health maintenance and uses a very different clinical logic, as discussed in the following paragraph.

In assessing symptoms of an acutely or chronically ill individual, multiple clinical hypotheses are generated from historical data and tested through physical examination and laboratory tests to arrive at the most plausible diagnosis and differential diagnosis. Levy and Ilif patents attempt to simulate such physician-directed diagnostic processes, which have many grey areas even in the hands of physicians. In case of generating health maintenance plans, recommendations are based on discrete and clearly identifiable factors such as age, sex, race, specific patterns in family history, genetic susceptibility (i.e. presence or absence of a specific gene), environmental exposure, life style choices, and screening tests. The process of creating a personalized health maintenance plan, an embodiment described in this application, is quite different from evaluation and management of symptoms of acute or chronic illnesses, the subject of disclosures by Levy and Ilif.

The U.S. Pat. No. 5,967,789 (1999) by Segel et al describes a system to help a person stop or modify an adverse habitual health-related behavior, such as smoking, weight control, stress management, etc. The computer receives personal information about the individual, which is relevant to the behavior, and makes use of the system software to provide customized messages in response. This method, focused on health related behaviors, does not attempt to elicit or utilize answers to specific clinical questions such as genetics and family history and apply medical knowledge base to arrive at a personalized, comprehensive health maintenance plan for the consumer.

The U.S. Pat. No. 5,879,163 (1999) by Brown et al describes an automated system including a questionnaire generator for questioning the individual to determine his or her motivational drivers and comprehension capacity. After generating a motivational and comprehension capacity profile, the system matches educational materials. This invention does not attempt to elicit answers to specific clinical questions such as genetics and family history and other clinical features such as BMI or laboratory findings and integrate medical knowledge to develop personalized, comprehensive health maintenance plan for the consumer.

In Publication # JPO 20000239A (2000), Akiyoshi Fujisaki describes use of data about rest, exercise, and eating habits from questions presented to individuals. Based on answers, improved methods are created for individuals from preset themes. The output is education about improved eating habits and exercise. The system does not customize recommendations based on age, sex, race, family history and other questions, and genetic risk analysis.

In a US Patent Application # 20100082367 A1 (2009), Hains et al describe a method for providing a wellness management program where the user is a patient, wellness professional is a pharmacist, and the wellness management program pertaining to patient's health is for medication management. Compliance with medication management is the chief goal of this pharmacist-assisted system. This application addresses one aspect of chronic illness management, namely medications, but does not attempt to utilize prevention related clinical algorithms for individuals who may not be ill.

Jeffery Doyel in the US Patent application # 2005/0149357 A1 describes a computerized system and method for generating and satisfying health maintenance item expectations in a health care environment. The application describes a process of scanning Electronic Medical Records or other types of medical databases in a health care institution to determine if expectations generated by USPSTF are satisfied and alert the clinician when they are not. However, the proposed system in the Doyel application does not address the need to educate and empower the consumer and develop health maintenance plan tailored to that individual's circumstances.

Extensive prior art search using USPTO website, Cassis and PubWest failed to reveal patents or patent applications in the area covered by our system. We also conducted search of non-patent literature including the World Wide Web to determine if systems for empowering consumers to develop personalized, comprehensive, preventive health care plans were deployed. Following paragraphs summarize the non-patent literature search.

The WebMD (http://www.webmd.com) offers access to thousands of articles on health topics listed alphabetically, from acne to jock itch and jet lag to zone diet. Searching for the term “health maintenance” presents 490 articles. The search for “preventive care” yields 680 articles. Customization to individual's needs and integration of individual's personal information to health maintenance plans is not available. Consumers of health care are likely to be overwhelmed by information on this site and would not be able to apply it to their own circumstances. Other health-literature-oriented websites include www.healthymagination.com and www.keas.com. Healthymagination has a section entitled “better health conversation”, which prepares the individual for a conversation with a physician about diabetes and heart disease. The individual is not able to enter age, sex, race, ethnicity, family history and other personal characteristics and receive a comprehensive preventive healthcare plan from healthymagination. The Keas website links the customer to one or more syndicated, non-personalized healthcare education material available on other websites or 3^{rd} party sources from which the user must choose from rather than a specific, personalized health maintenance plan for the customer that a robust clinical algorithm could generate by analyzing a wide array of customer attributes. For example, the web site does not collect race or ethnicity information or detailed family history (e.g. medical information about second degree relatives), which are critical for recognition of predisposition to preventable diseases or heritable patterns for personalization of health maintenance plans. Additionally given a list of technical names such as Otitis Media, COPD, Streptococcal throat and so on, it is unlikely that an average member of public will even be able to choose an appropriate disease to prevent.

The NCI (http:www.cancer.gov/bcrisktool/) lists voluminous information about more than 10 cancers including clinical research and trials, treatments, research grants and prevention. Tools (e.g. a risk assessment tool for predicting percentage risk of breast cancer) are designed for use by health professionals and researchers. The consumer will not be able to use the risk data, review clinical trials funded by NIH or learn about their own cancer prevention plans. Moreover, in NCI or similar disease-oriented websites, the individual must select a disease that he or she wishes to learn about or prevent. However, consumers usually do not have the expertise to select appropriate diseases for prevention based on their own personal circumstances.

In Summary, shortcomings of the prior art are as follows:
Some computerized applications, reviewed above, address the needs of the health care system and health care providers rather than the needs of consumers. The tools lack recognition of individual consumer's needs and are not written in non-technical language.
Although efforts have been made to create tools for self-diagnosis of acute and chronic illnesses through analysis of symptoms reported by consumers, generally such efforts have failed. It is extremely difficult to develop binary algorithms in areas of clinical medicine that require clinical judgment and where an individual without medical background may not have the skills for objective evaluation of symptoms. Moreover, these applications do not attempt preventive health maintenance and use a very different clinical reasoning process.
Previously granted patents or patent applications do not provide health maintenance plans customized to individuals based on their age, sex, race and ethnicity, family history and other risk factors as we disclose in one of the embodiments of our application. This is also true for non-patented commercial or government Websites.
Previous patents, patent applications and publicly available tools for consumers miss the opportunity to integrate benefits of genetic information from the Human Genome Project, applied prudently on the basis of family history, race and ethnicity and other risk factors.
The systems, described in the above prior art, do not develop personalized, comprehensive health maintenance plans and checklists with timelines. Consequently, updates of completed action on an individual's personalized, specific plan are not available.

Recent proliferation of personalized devices, systems and sites such as computerized social networks and hand held devices that combine internet and cell phones (SmartPhones) present an opportunity for at least one embodiments of our process to improve health literacy of the consumer, and increase the use of preventive health maintenance. This will promote health, prevent needless suffering from preventable illnesses and reduce health care costs.

### OBJECTS AND ADVANTAGES

We disclose a system (i.e. a process which can be embedded or deployed in computerized devices) whereby, in at least one embodiment, an individual consumer is able to enter information about his or her age, sex, race and ethnicity, life style and historical facts such as family history and receive a personalized health maintenance plan. The plans are derived from collection of medical knowledge; recommendations from large number of professional organizations are synthesized and consolidated by a consumer oriented expert panel. The recommendations are converted from a technical form to non-technical, consumer friendly form and adapted to the Internet, social networks on the Internet or Internet enabled digital devices such as SmartPhones. The system selects from a large number of health maintenance options, by a process of elimination, those that are appropriate for individual's age, race/ethnicity and gender, lifestyle as well as historical facts such as family history and presents only those recommendations that are customized to that individual in non-technical terms. In determining appropriateness of health maintenance recommendations, needs of the individual receive the prime consideration; not that of the insurance company, health professional, hospital or national health expenditure. Cost information is presented to the consumer so that he or she may make informed choices. In one of the embodiments, the narrative plan is also converted into a checklist of actions and a time line, which can be updated by the consumer as various steps in the action plan are completed. Armed with this information, i.e. a personalized health maintenance plan, the consumer is able to utilize the health care system more efficiently. To further personalize, the automated system assists the consumer in following up progress and presents reminders, encouragement, support and educational resources. In another embodiment, the consumer operated, automated system is also capable of variety of methods of updates and reminders, e.g. record completion of a portion of the plan or entire plan by the consumer or obtaining such information through an interface with an Electronic Medical Record (EMR) within the guidelines of the EMR systems and applicable laws. Consequently, the probability of omitting a critical health maintenance procedure is reduced.

Specifically, several objects and advantages of the present invention are:
a. conversion of medical knowledge and recommendations emanating from large number of professional organizations into health maintenance options designed to prevent disease categories with high mortality and morbidity in the United States,
b. integration of information and benefits from the Human Genome Project by prudent application of family history, risk analysis and genetic screening,
c. elimination of those options that are not appropriate for the individual based on their age, race/ethnicity, gender, lifestyle, family history and historical facts,
d. presentation of a set of recommendations that are appropriate for age, race/ethnicity, gender, family history, lifestyle and historical facts, i.e. a personalized health maintenance plan, in non-technical form and language,
e. giving primary importance to individual consumer's needs and wishes rather than consideration of national health expenditure (e.g. through government agencies such as AHRQ/USPSTF or CMS), health care provider point of view (e.g. AMA, ACS, AAP, etc.), institutional and industry perspective (e.g. hospitals or insurance companies) or pharmaceutical industry,
f. adaptation of the personalized health maintenance plan to the Internet, social networks on the Internet and hand held, portable, internet enabled devices (PDA's, SmartPhones etc),
g. enabling the consumer to either enter his or her age, race/ethnicity, gender and lifestyle as well as key historical facts as stated above or with appropriate consent, collecting that information directly from user profiles already entered at a social networking site and arriving at a personalized health maintenance plan,
h. being able to export the plan to another system, e.g. physician's office or insurance company as permitted by the receiving system and with consent of the consumer,
i. providing additional references or reading materials to further inform the consumer,
j. providing additional education, e.g. video demonstration of self-examination of breast for lumps to prevent breast cancer,
k. providing general advice about implementation of the health maintenance plan either by individual's own efforts (e.g. reduce caloric intake or increase physical activity or perform self-examination of testicles) or seeking the assistance of health care providers (e.g. administration of influenza vaccination or performance of colonoscopy or clinical examination of the breast for detection of cancer or scheduling mammography),
l. being able to update the plan as various steps are completed in part or whole, either by the consumer or interfacing with their EMR,
m. being able to receive reminders from the system via text messages or emails to remind patients to complete different steps of their personalized health maintenance plan in a timely manner,
n. being able to receive reminders from other systems such as health plan, physician's office or hospitals via text messages or emails, if such an option is chosen and is available from other systems,
o. utilizing new tools available to consumers such as the Internet, social networks or hand held mobile devices such as PDA's or SmartPhones
p. continuously and periodically learning from experience based on feedback from the consumers as well as expert panels.

With improved information about an appropriate health maintenance plan, the consumer will be able to (1) utilize the health care system and personnel more efficiently, e.g. use the limited time of primary care provider to obtain needed preventive health care, (2) engage in more healthy life style, (3) advise his family and friends about preventive maintenance and healthy life style and (4) help reduce the overall cost of healthcare by proactive management of health rather than needing costly cures. Finally, improved health literacy will reduce or eliminate health disparities in underserved and minority populations that have poor access to health care, especially primary care, by making available information that often comes from interactions with primary care providers.

One of several unique features of the automated system is its ability to execute a multi-variable, multi-dimensional synthesis of specialized clinical information and conduct a complex reasoning process (equivalent to a time consuming, complex decision making process by a panel of preventive care clinical experts). Another unique feature is its ability to utilize family history and other factors to make prudent decisions about genetic screening and benefit from vast amount of new information about genetic susceptibility emanating from the Human Genome Project. The system automatically delivers an unexpected, not easily realizable outcome within a fraction of a second. While standard technological tools (e.g. html, PHP, MySQL, other object oriented programming languages and relational database etc) are used to develop the system, the assembly of the above algorithms is unique in terms of (1) technology enablement of the synthesis and interpretation of huge quantities of complex clinical information and matching it uniquely to comprehensive details on the consumer's personal characteristics to deliver a reliable, personalized health maintenance plan and (2) user interface design, to interact with a consumer with no prior clinical expertise, to gather relevant and adequate information in a sequence and extent that is determined by the specific information that is provided by the consumer.

### SUMMARY

One embodiment creates a system and a process, which enables the consumer to enter age, sex, race and ethnicity, life style and historical information such as family history and receive a personalized health maintenance plan(s). The process includes (i) synthesis of medical knowledge to generate consumer-oriented health maintenance recommendations; (ii) collection, analysis and synthesis of information from an individual consumer and (iii) selecting appropriate health maintenance plans to circumstances of the individual consumer. The embodiment includes the use of a computer hardware and software system designed to automate the process and assists the consumer in implementing and updating such a plan.

### DRAWING

### Figures

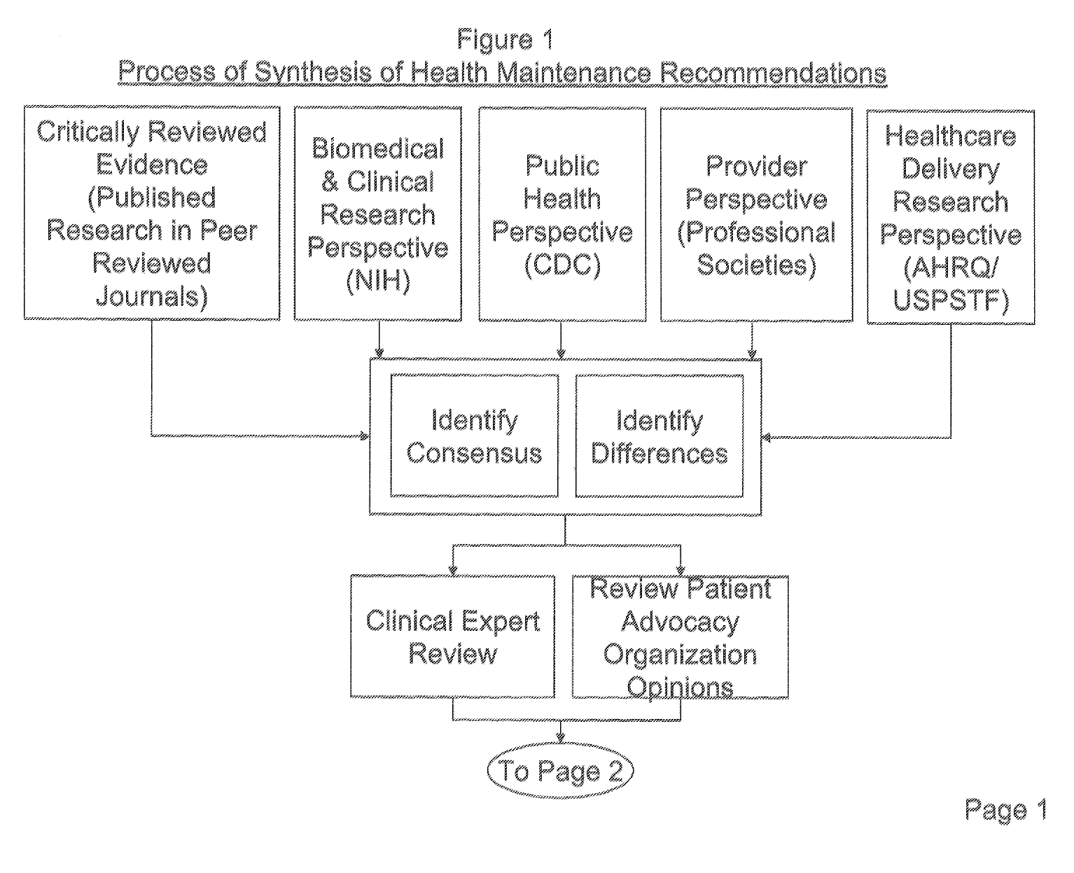

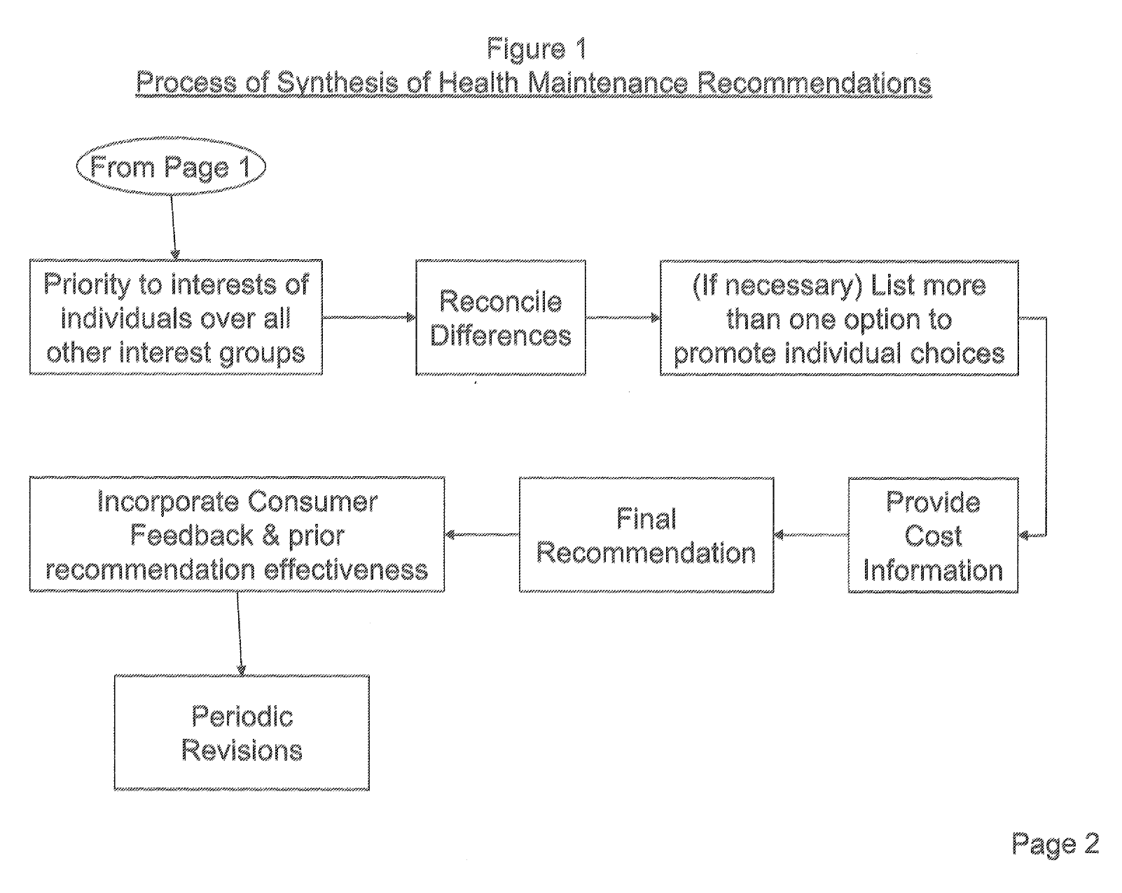

FIG. 1 describes a process of synthesis of health maintenance recommendations to develop consumer oriented health maintenance plans.

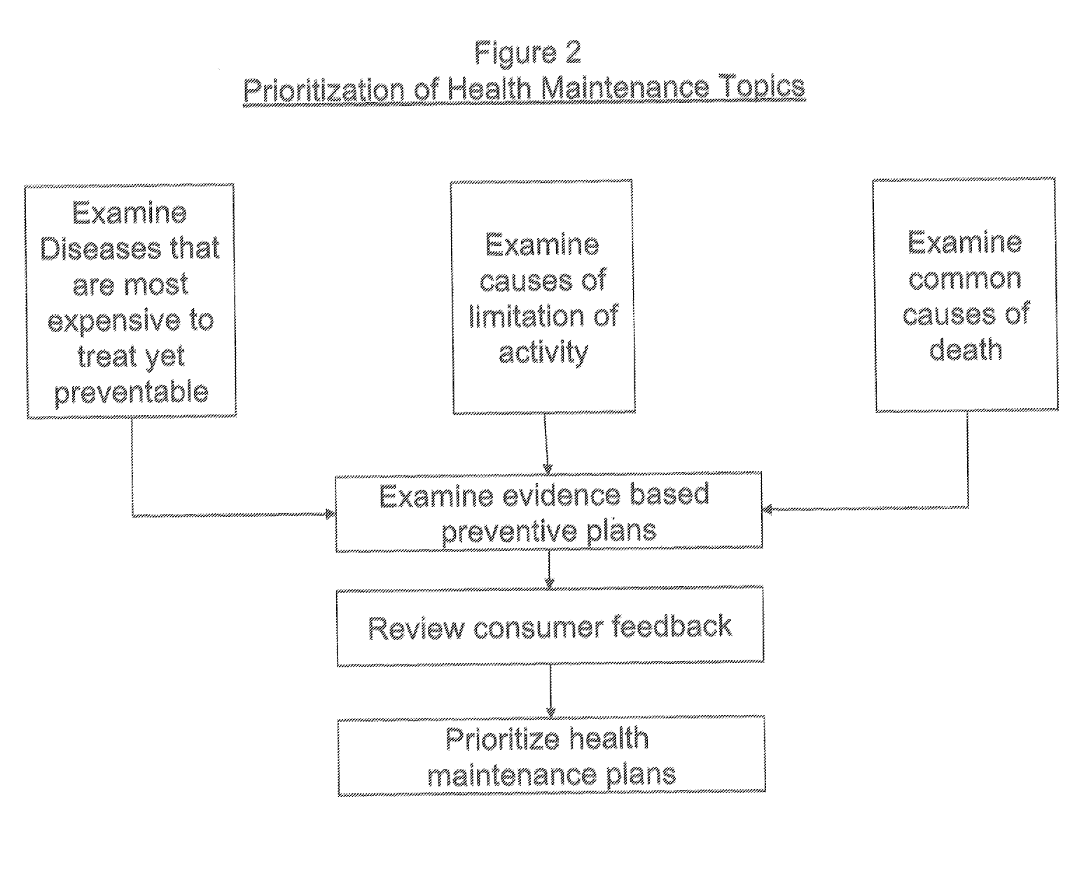

FIG. 2 describes the process of prioritization of health maintenance topics.

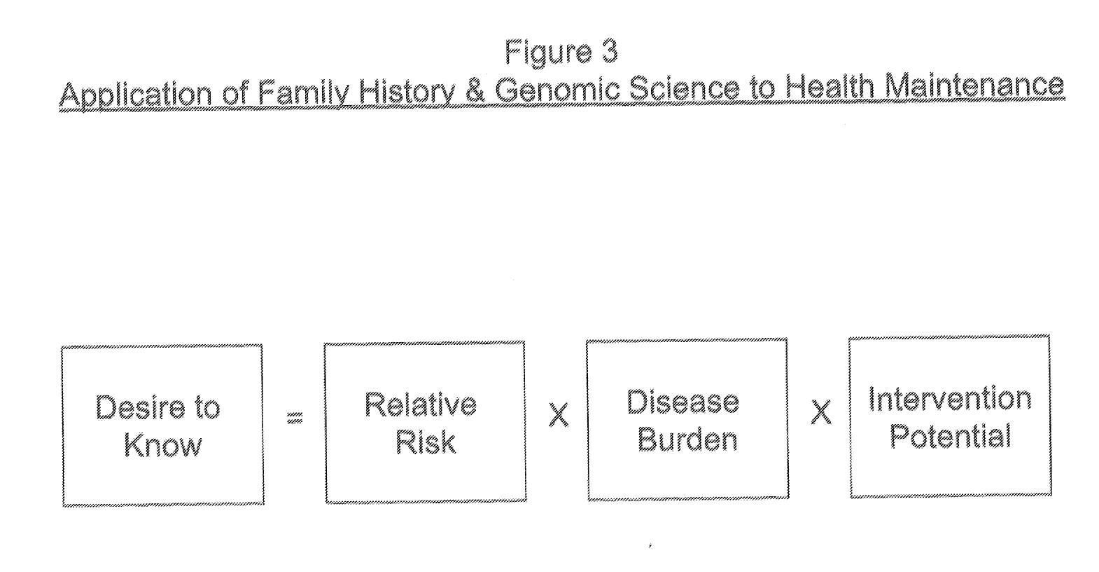

FIG. 3 describes the application of family history and genomic science to health maintenance.

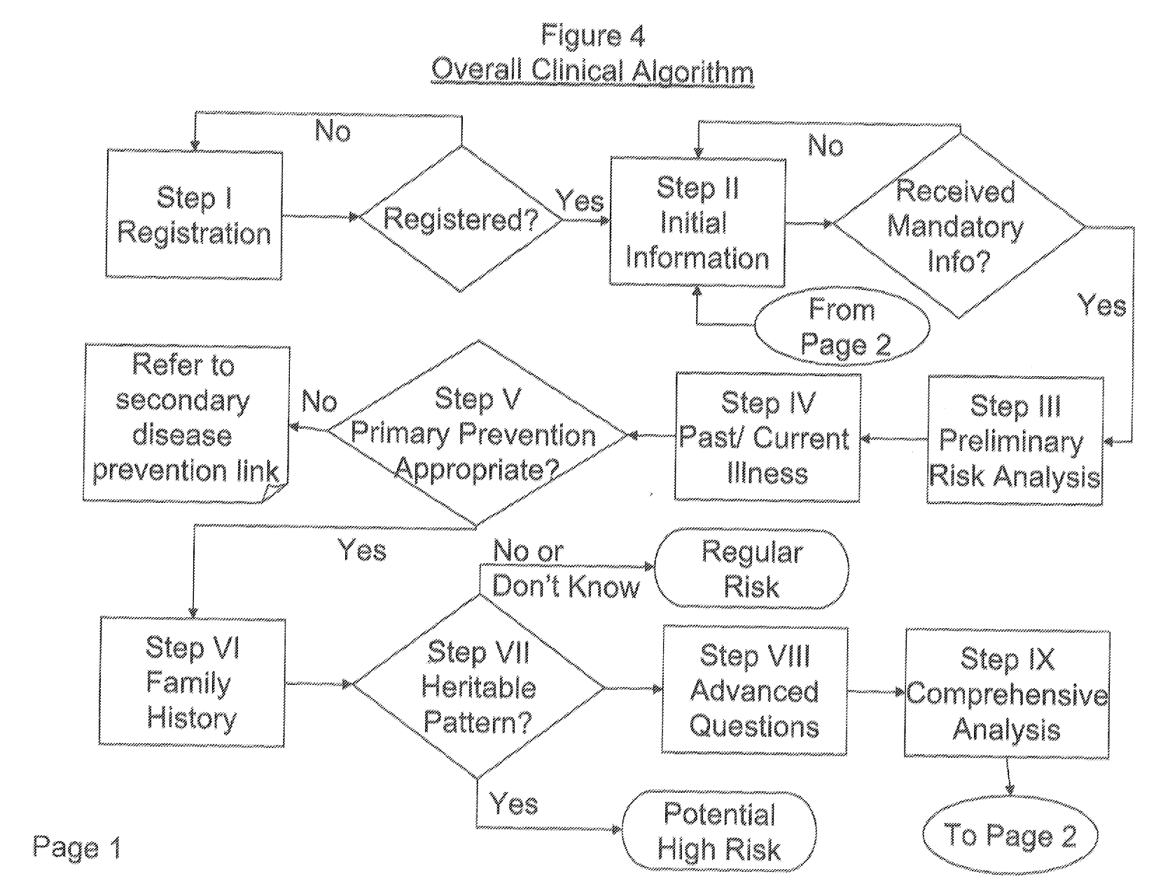

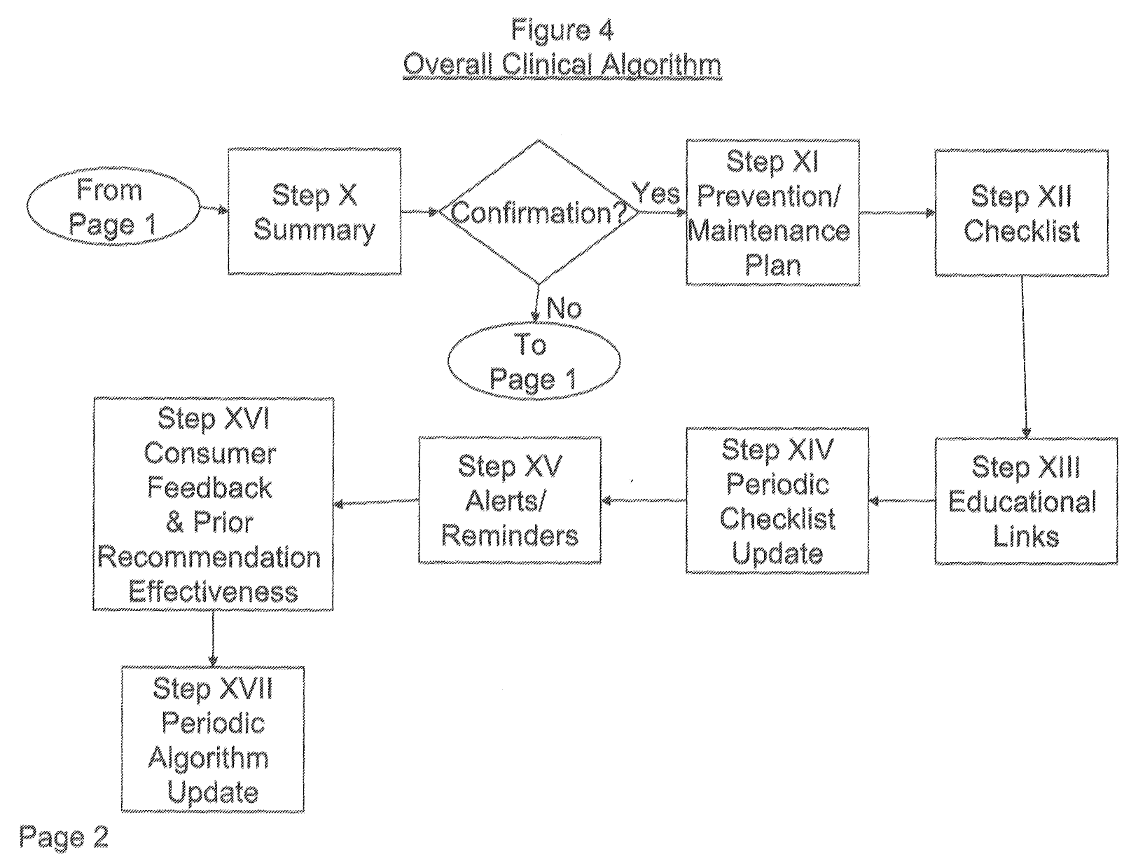

FIG. 4 presents an outline of overall clinical algorithm embedded in the system to develop health maintenance plans targeting multiple medical conditions, e.g. cancers of various organs, nutrition and obesity, diabetes, heart disease, immunization and infectious diseases, arthritis, mental health issues, injuries, etc.

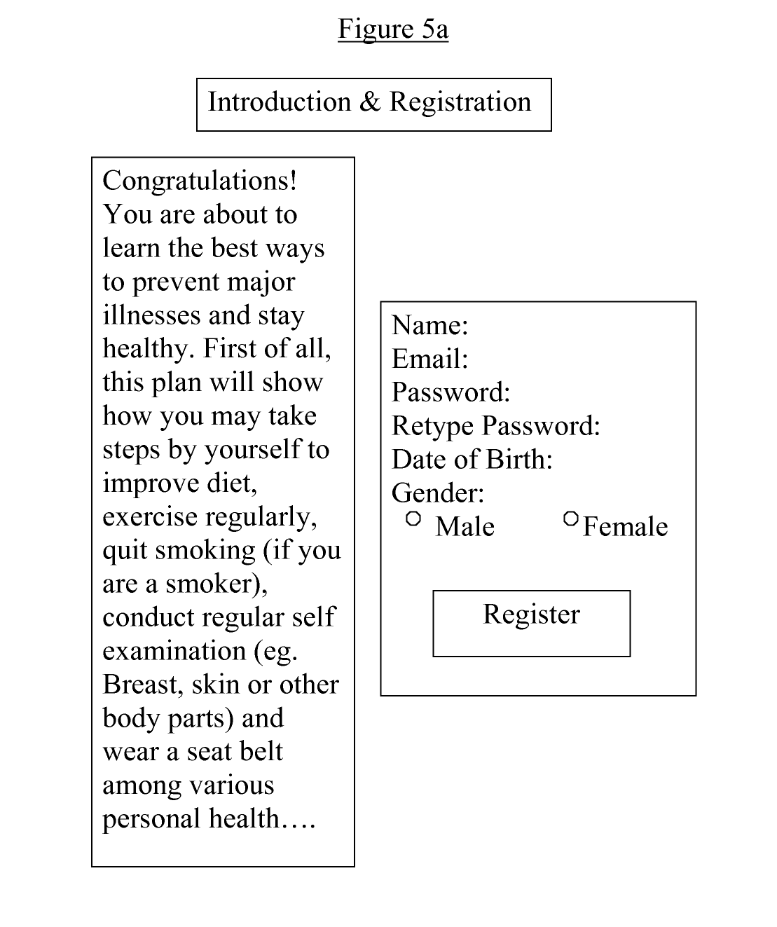

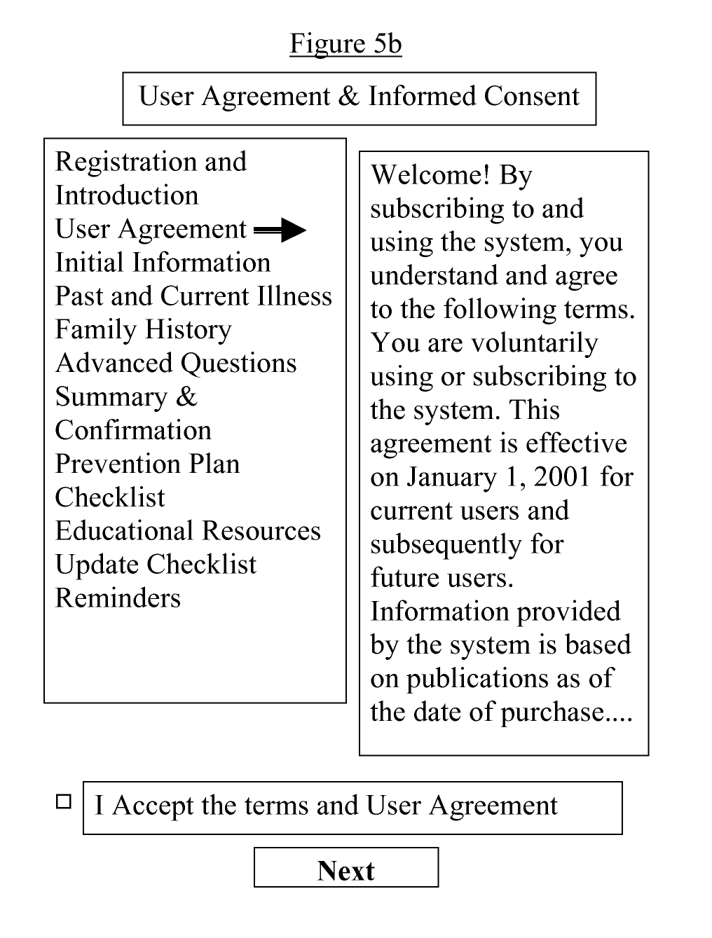

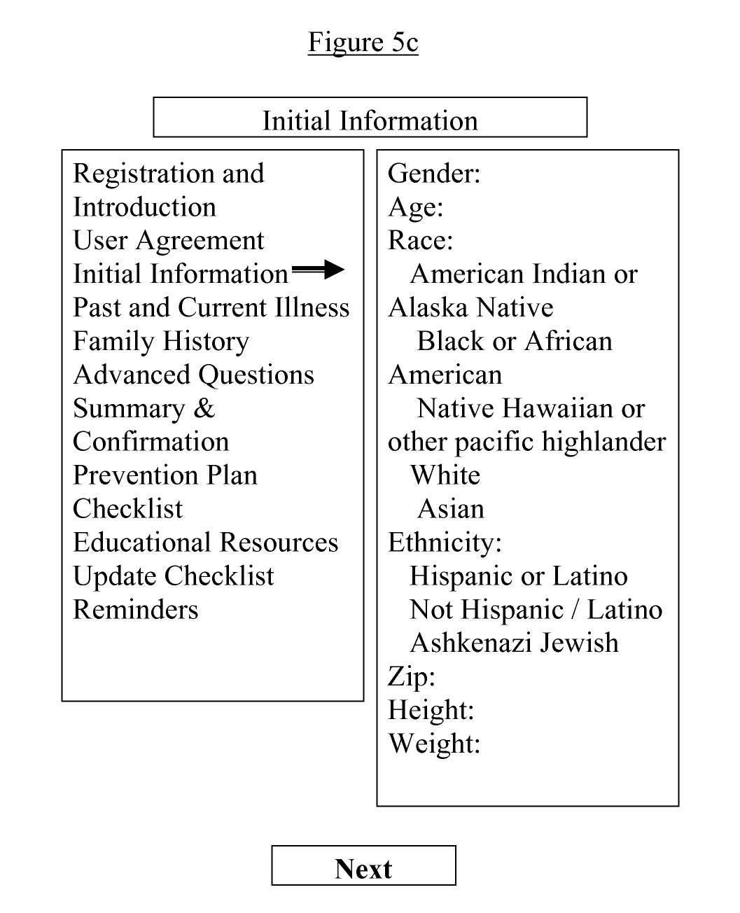

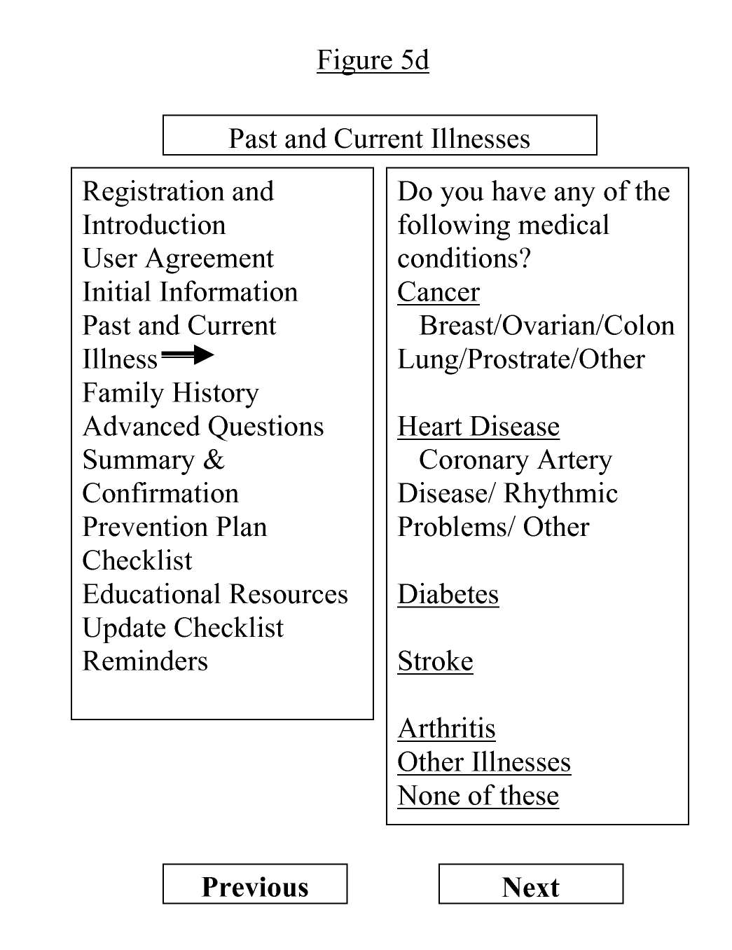

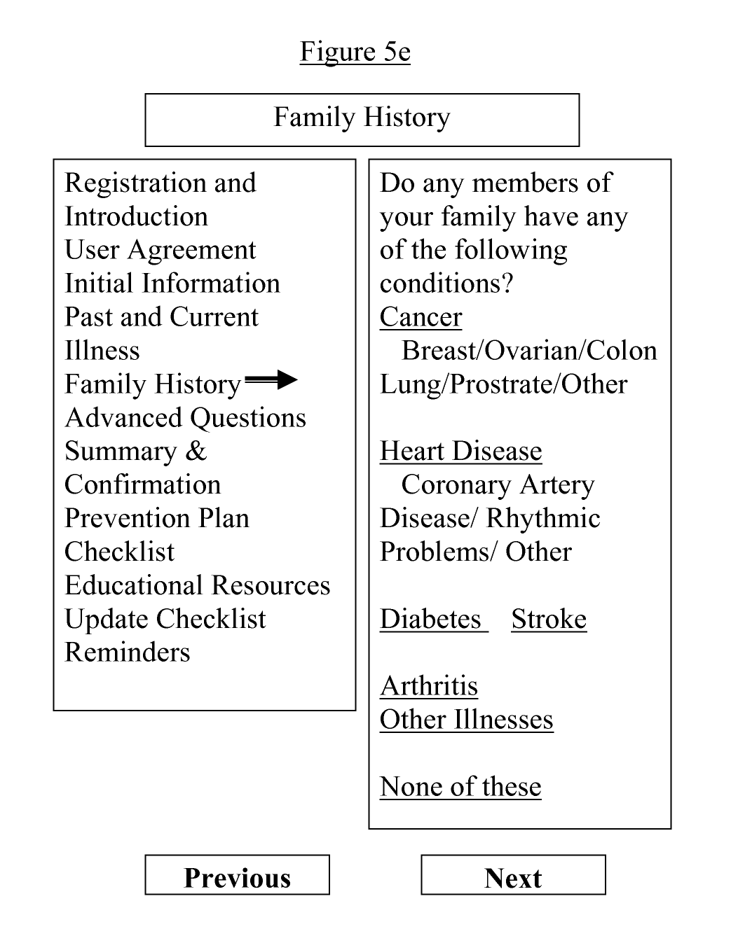

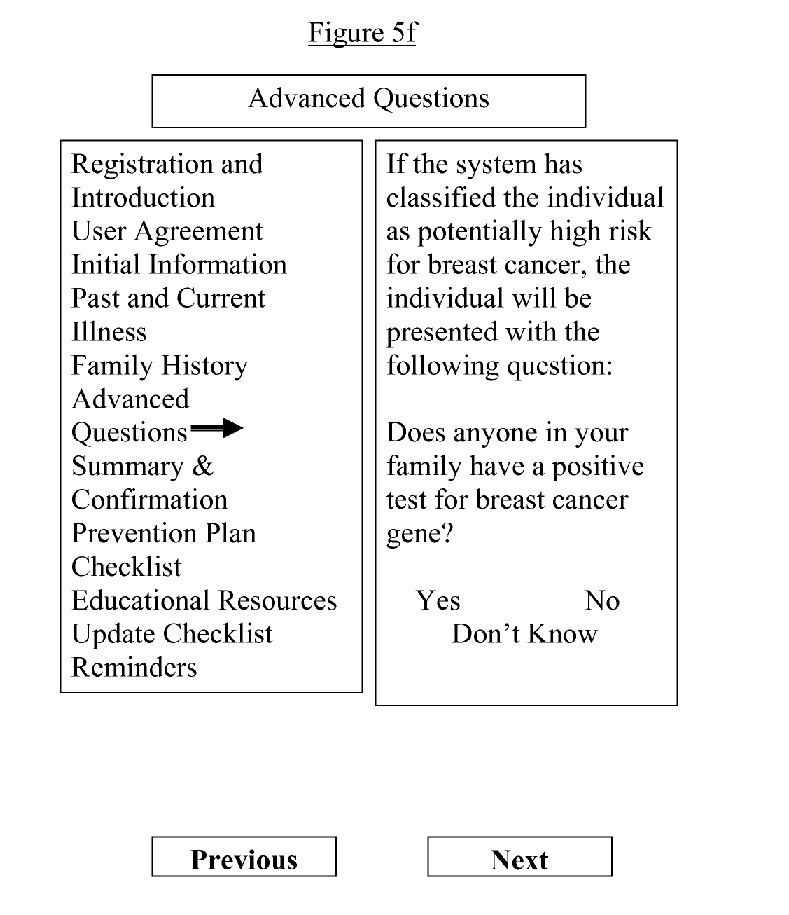

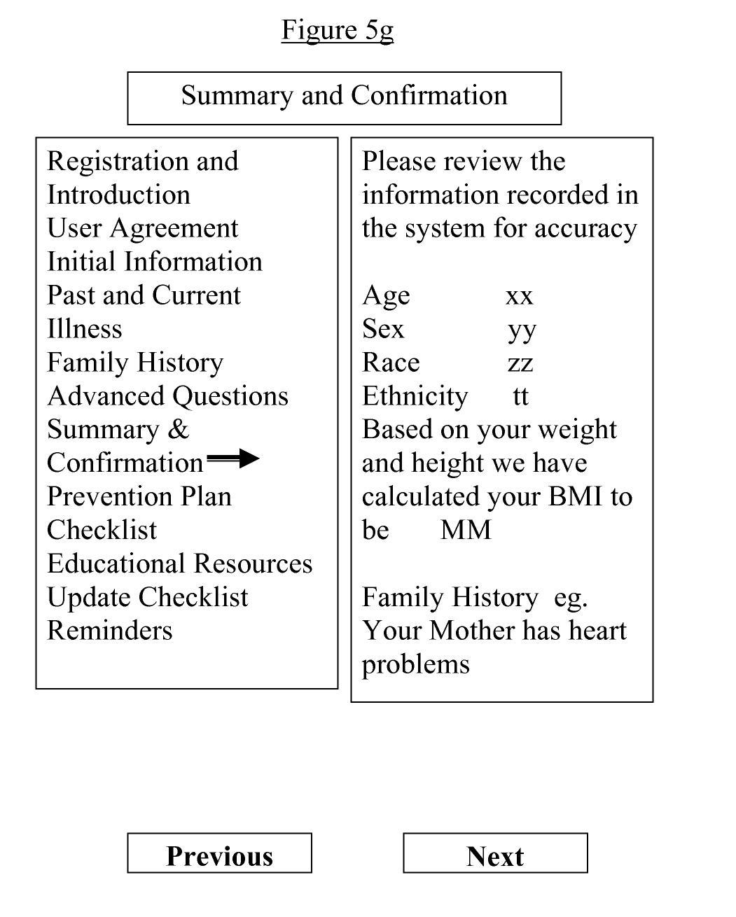

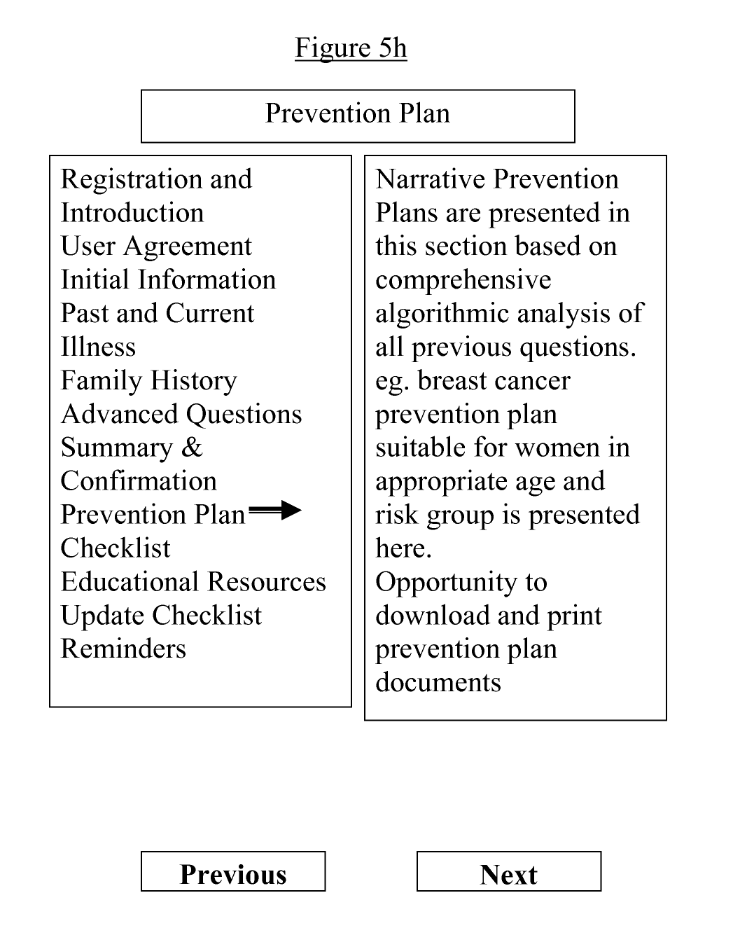

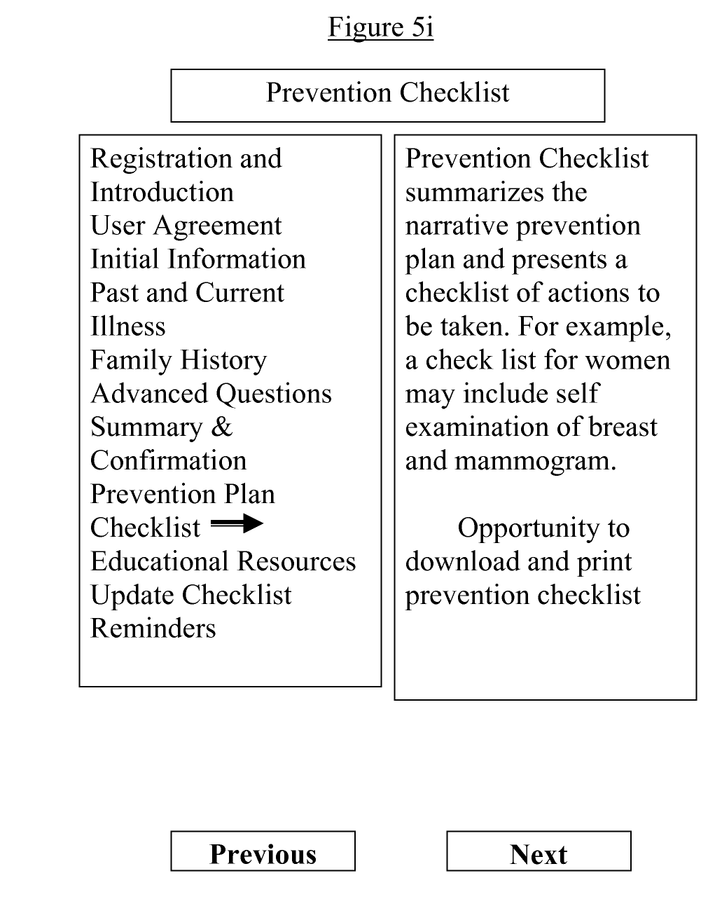

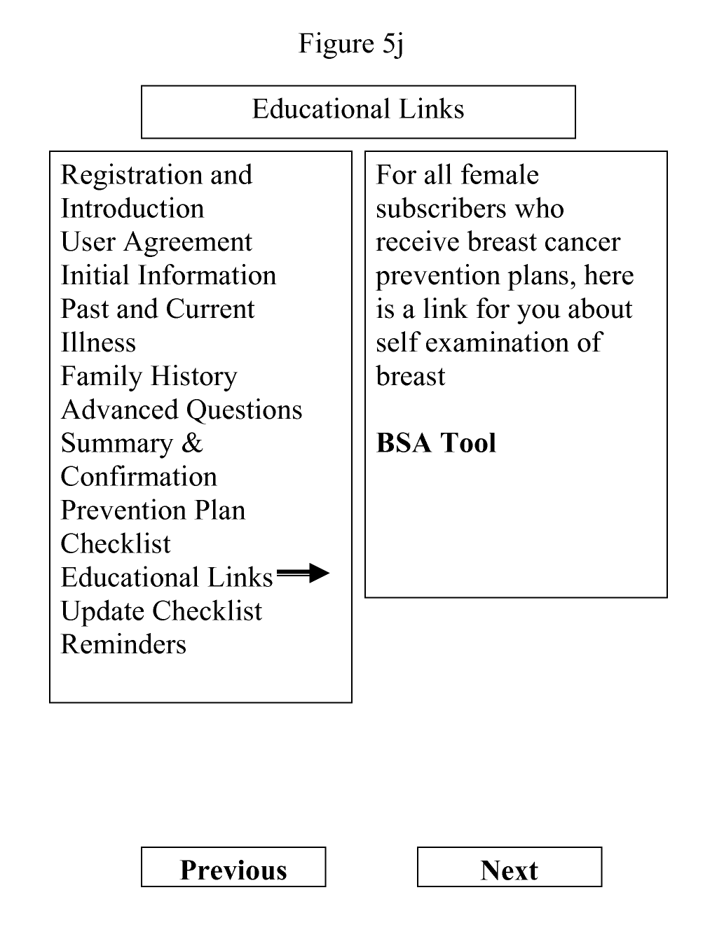

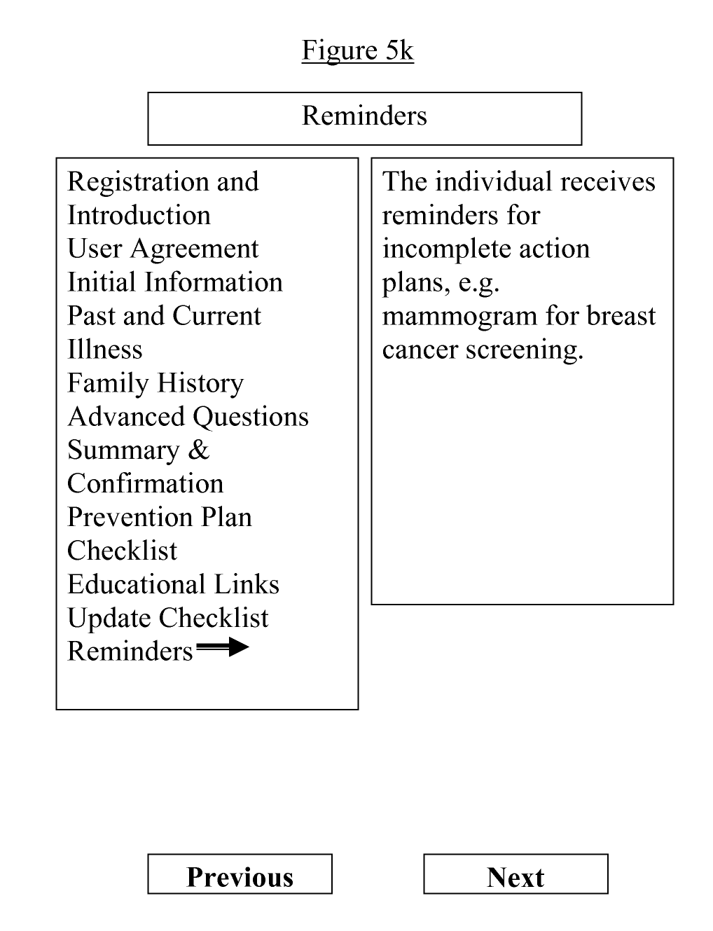

FIG. 5 presents an outline of the system and includes interaction between the consumer, the user interface and the system.

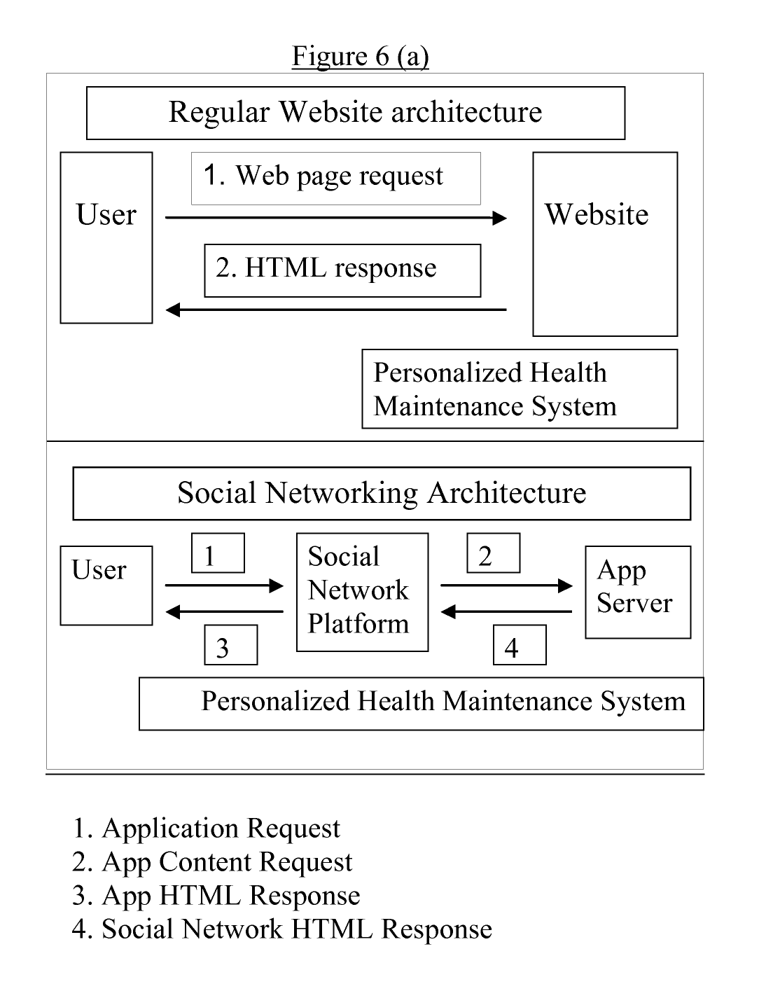

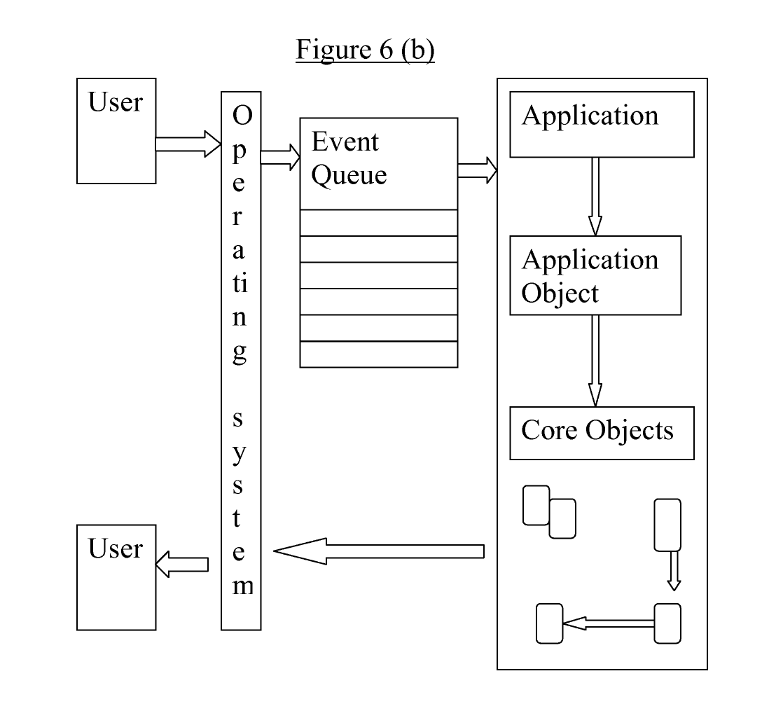

FIG. 6 presents technological architecture showing how the system will work and how it will be adapted to Internet enabled hand held devices such as PDA, Blackberry, iPhone and other SmartPhones and social networks on the Internet

### DETAILED DESCRIPTION

### FIG. 1 through FIG. 6, Operation of the System and First Embodiment

The first embodiment of the enabling process for personalized health maintenance includes the process of synthesis of health maintenance recommendations emanating from variety of expert panels, scientific and professional organizations, prioritization of evidence based preventive plans on the basis of mortality and morbidity statistics and the application of genomic science as shown in FIGS. 1, 2 and 3. An outline of the process of development of the overall clinical algorithm is shown in FIG. 4 and is further illustrated through several examples (Example A: Breast Cancer Prevention; Example B: Type II Diabetes Prevention; Example C: Sickle Cell Disease Prevention. FIGS. 5 and 6 show the automated system describing how the consumer interacts with the system (the User Interface), how the consumer information flows through the system and the output received.

FIG. 1 describes how the system synthesizes evidence based health maintenance recommendations from various expert panels, scientific and professional organizations. For example, critically reviewed literature published in peer-reviewed journals represents the science at the cutting edge. Biomedical and clinical research perspective is provided by 27 institutes and centers of the National Institutes of Health. Centers for Disease Control and Prevention (CDC) publishes population and public health issues but they may or may not be same as consideration of individual's health issues. Various physician specialty societies, e.g. AMA, AAP, ACS and so on, describe not only medical expertise but also provider perspective. The USPSTF, a committee appointed by AHRQ (a government agency) describes healthcare delivery research perspective and takes into account national health expenditure. However, the prime consideration of this automated system is consumer's perspective; not the perspective of research community, providers, public health community, insurance companies or pharmaceutical industry. Process of synthesis begins with identification of consensus and conflicts (i.e. differences) among recommendations from various professional and scientific interest groups. Consensus and conflicts are examined not only by clinical experts but also by patient advocacy organizations. In resolving differences, priority is given to interests of individuals over all other interest groups. Where differences cannot be reconciled, more than one option is presented so that the consumer can make an informed choice. Costs, especially average out-of-pocket costs to the individual, are presented to assist the consumer in making the choices. The final recommendations, prepared in non-technical language, are embedded in the automated system, and periodically revised based on consumer feedback and evaluation of plan effectiveness.

FIG. 2 describes the process of prioritization of health maintenance topics. Common causes of death in the United States, conditions that limit activities (i.e. produce functional impairment), and preventable diseases or medical conditions that are most expensive to treat, if not prevented, are listed. Evidence for preventive plans for each of the conditions is examined. Consumer feedback guides the priority among those conditions that are fatal, disabling and costly but where evidence based preventive plans are available. This process allows selection of health maintenance topics based on the needs of maximum number of consumers rather than those select conditions that may be of interest to research community (often unusual and interesting entities) or provider community (income producing procedures) or pharmaceutical industry (conditions that require drugs for prevention) and so on.

FIG. 3 describes the application of family history and genomic science to health maintenance. Since the goal of the system is to personalize the health maintenance plan, there is nothing more personal than the genes an individual inherits. Knowledge about one's genetic susceptibility allows customization of preventive plan including avoidance of certain environmental exposure or life style choices that may activate or influence the unfavorable gene. Since there are more than 20,000 genes and the process of sequencing all genes in an individual is prohibitively expensive, a prudent selection process must be employed.

Selection is based on a generally accepted process, best articulated recently by Francis Collins, Director of NIH and former Director of Human Genome Institute (Language of Life, Harper Collins Publishers, 2010). Relative risk of a genetic condition calculated for an individual in a specific population (e.g. breast cancer in an individual with Ashkenazi Jewish ancestry and positive family history, Sickle Cell Disease in African Americans, Diabetes in Pima Indians or in individuals with strong family history of diabetes, etc.). The disease burden refers to the impact of the disease on individuals and allows prioritization of those heritable conditions that have high mortality and morbidity versus those that produce little or no clinical effects such as color of eyes. Finally, potential for intervention focuses the priority to those conditions where evidence based intervention or prevention is available. For example, in Alzheimer's disease, there is high prevalence in older population and a very high disease burden but absence of evidence based preventive or disease intervention tools. On the other hand, cancers of breast, colon and prostate, obesity and diabetes, sickle cell disease and many other conditions meet all tests, namely high prevalence, disease impact and availability of prevention and interventions. Therefore, at this time, the automated system focuses on those conditions rather than on Alzheimer's.

General principles governing the use of family history and racial/ethnic background in the clinical algorithm are exemplified in the following table. The system examines the information given by the user for following patterns and if high-risk situations are identified, the algorithm presents relevant education, actions the consumer can take and a plan including consultation with a physician and a genetic counselor.

| | FAMILY HISTORY | RACIAL AND ETHNIC |
|---|---|---|
| INDIVIDUAL FACTORS | PATTERNS | BACKGROUND |
| Multiple primary tumors | One first degree relative | African Americans and |
| Younger than usual age at | with same or related tumor | Alaska Natives for prostate |
| tumor diagnosis (e.g. breast | Two or more first degree | cancer |
| cancer before age 50 years | relatives with tumor of the | Ashkenazi Jewish for |
| or prostate cancer before 65 | same site | Breast Cancer |
| years) | Three or more relatives in | African Americans, Alaska |
| Unusual cancer (breast | two generations with | Natives or American |
| cancer in a man) | similar tumors | Indians, Pacific Islanders, |
| Association with other | Special situations: paternal | Asian Americans and |
| genetic traits and congenital | aunt and paternal | Hispanics for Diabetes |
| defects | grandmother affected with a | |
| Skin lesions predisposing to | genetic cancer generally | |
| cancer | found in women presenting | |
| Hyperpigmentation of skin | a high risk for daughters) | |
| associated with obesity and | Parent or sibling with Diabetes | |
| diabetes | | |

Specific examples of diseases for which the Clinical Algorithm examines family history and race/ethnicity, detect high-risk patterns, and develop a personalized preventive health maintenance plans are shown in the following table (pages 23-24)

| | FAMILY | | |
|---|---|---|---|
| | HISTORY AND | GENES TO BE | PREVENTIVE |
| DISEASE | RACE/ETHNICITY | CONSIDERED | CARE PLAN |
| Breast Cancer | If First Degree | Consider BRCA1 | Earlier initiation of |
| | Relative (FDR) | and BRCA2 gene | mammography |
| | Positive, Relative | mutations | Chemoprevention |
| | Risk (RR) = 2.1 | TP53 mutations | Other approaches |
| | Second Degree | PTEN mutations | |
| | Relative (SDR) with | CHEK2 mutations | |
| | Paternal Aunt and | AT mutation | |
| | Paternal | | |
| | Grandmother | | |
| | positive | | |
| | Ashkenazi Jewish | | |
| | Ancestry with any | | |
| | positive family | | |
| | history | | |
| Ovarian Cancer | First Degree | BRCA1 and | (investigational) |
| | Relative RR = 3.1 | BRCA2 mutations | Pelvic Exam |
| | | OMIM mutations | Ultrasound |
| | | | CA-125 assay |
| Prostate Cancer | Brother or Father | BRCA1 and | Earlier and more |
| | with Prostate | BRCA2 mutations | rigorous initiation of |
| | Cancer; RR = 2.2 to | HPC1 mutation | Prostate Specific |
| | 3.4 | Other prostate | Antigen (PSA) test |
| | FDR before 65 | cancer susceptibility | Digital Rectal |
| | years; RR = 3.3 | loci | Examination |
| | Family history of | | |
| | breast cancer; RR = 1.7 | | |
| Diabetes | Parent, brother or | Polygenic | For individuals less |
| | sister with diabetes; | | than 45 years of age, |
| | RR >8 (depending | | overweight (BMI |
| | on number of FDR | | greater than 25) and |
| | affected) | | one risk factor |
| | Alaska Native, | | would suggest the |
| | American Indian, | | need for diabetes |
| | African American, | | evaluation |
| | Hispanic/Latino, | | Weight loss through |
| | Asian American, or | | better nutrition and |
| | Pacific Islander; RR = | | exercise |
| | 2.0 compared to | | |
| | non-Hispanic white | | |

The examples in the above table are not to be construed as limiting.

Environmental exposure and lifestyle factors interact with genetic susceptibility to produce a given disease. Decisions such as screening and early detection as well as counseling and medical management are influenced by knowledge of genetic susceptibility. As discussed in the background section, family history, race/ethnicity and other factors such as age serve as proxy for selection of individuals for further genetic counseling and screening. The purpose is to individualize the preventive healthcare plan for the consumer. Detailed family history and complex analysis embedded in this automated system allows selection of individuals who would benefit from selective genetic screening as illustrated in the breast cancer prevention, sickle cell disease and diabetes examples below. As described in the background, our health care system continues to exhibit serious deficiencies in application of family history and genomic science. In fact, preventive plans based on individual's genetic susceptibility are rarely available unless the consumer is persistent and well informed, and seeks experts with appropriate knowledge (e.g. geneticists, physician scientists, genetic counselors, etc.) Unique feature of the clinical algorithm, with an unexpected and non-obvious outcome, is that it allows selection of those individuals who should be informed about their genetic risks. They are given a choice to obtain additional genetic information necessary for their individualized health maintenance plans.

FIG. 4 describes an outline of overall clinical algorithm embedded in the system. After an initial process of registration during which informed consent is obtained, the consumer is asked basic questions about age, sex, racial and ethnic background, height and weight (from which Body Mass Index-BMI is calculated). Mandatory information is defined as data necessary to generate personalized health maintenance plan while desirable information allows refinement of plans but may not be available at the time consumer begins the process. The system performs a preliminary risk assessment. As illustrated in the examples below, Ashkenazi Jewish ancestry is relevant to breast cancer prevention while African American ancestry is relevant to sickle cell disease and so on.

During Step IV, the algorithm takes an inventory of past and current illnesses so that primary prevention plans would be presented only if appropriate. For example, if someone already has breast cancer, it would be inappropriate to provide a preventive plan for breast cancer. That individual can receive other preventive plans (e.g. prevention of diabetes, vaccine preventable infections, injuries, etc.) In addition, secondary prevention plans (e.g. cancer in the second breast in this example) can be presented.

During Step V, the algorithm collects history of preventable conditions in the family, not only in immediate first-degree relatives but also, in second-degree relatives. Through preprogrammed algorithm, the system determines if patterns of heritable diseases are detected in the family of the individual consumer as illustrated in the examples below. Detecting such patterns is the best way of determining whether the consumer would benefit from appropriate genetic tests. Then, the system determines whether the consumer is potentially at high risk of a heritable condition or should be classified as standard or average risk. If the status were unknown (e.g. in an orphan who cannot provide family history), the default would be to consider standard risk in developing the preventive plan until relevant information is added.

The next step is to present advanced questions based on answers provided during previous steps. For example, prostate cancer related questions are not asked of a woman since females do not have a prostate gland. Similarly, males are not asked questions about age of menstruation or pregnancy. To illustrate another example, family history of premature death from cardiovascular causes in the immediate relatives would indicate obtaining blood lipid levels in younger individual, even children, while in the absence of such a history, the blood lipids may be obtained only in men over 35 years of age and women over 45 years. After responses to advanced questions are obtained, the system performs comprehensive analysis considering all relationships (i.e. permutations and combinations of responses that fit known risk patterns) to determine selection of appropriate health maintenance plan for that individual. The consumer is provided a summary of all information gathered and given an opportunity to edit any inaccuracies.

If the accuracy is confirmed, the consumer is provided a narrative, customized, health maintenance plan. Recommendations applicable to only those with specific history are listed (e.g. more frequent blood glucose and Hemoglobin A1c determination in those with history of diabetes in one or both parents). An exhaustive list of recommendations is reduced to a limited number of applicable options by an algorithm driven by software based on classes of patients with different combinations of age, race/ethnicity, gender, family history and lifestyle. Thus, upon entering responses to questions presented by the software application, the consumer receives a personalized health maintenance plan.

Each narrative plan has an associated checklist of steps the consumer may consider taking along with a timeline for action. The consumer receives educational links for steps where such assistance is necessary. He or she is able to update the checklist for completion of steps. The system checks for incomplete actions and not only provides reminders and alerts but also, further education and support. Consumer's feedback, plan effectiveness and major changes in recommendations (e.g. emergence of a new infectious epidemic requiring immunization) are considered in updating the algorithm.

One embodiment, based on our current analysis but not to be construed as limiting, includes preventive, health maintenance plans for the following conditions:
a. Cancers of breast, colon, lung, prostate, skin and other organs
b. Heart Disease and Hypertension
c. Stroke
d. Emphysema and Chronic Lung Diseases
e. Nutritional Disorders, Obesity and Diabetes
f. Inherited conditions for which newborn screening and preventive plans are available such as sickle cell disease, hypothyroidism, phenylketonuria, galactosemia, cystic fibrosis, etc.
g. Infectious Diseases (vaccine preventable as well as those with other preventive strategies)
h. Mental health and behavioral disorders
i. Arthritis and musculoskeletal disorders
j. Injuries and accidents

Of the above conditions, we present three examples; breast cancer prevention is presented in greater detail to illustrate the use of algorithm but should not be construed as limiting the scope. Examples of Diabetes and Sickle Cell Disease and Trait are summarized to illustrate how the clinical algorithm will address diverse medical conditions and various racial/ethnic groups.

### Example A

### Breast Cancer Prevention

In 2010, more than 200,000 women will be diagnosed of invasive breast cancer and more than 39,000 will die. Learning about early detection and getting regular screening tests is the best way of lowering the risk of dying from breast cancer. However, age at which screening should begin and the methods of early detection are selected based on individual's risks. The algorithm embedded in the automated system incorporates various factors. In this case, the algorithm detects race/ethnicity (Ashkenazi Jewish women having higher probability of inheriting the breast cancer susceptibility genes called BRCA1 and BRCA2) and family history. History of mother or sister (or any first degree relative) having breast cancer before age 50 years indicates a high risk. The algorithm also looks for subtle patterns, often not apparent to an unskilled individual; for example, an individual whose paternal aunt and paternal grandmother had breast cancer is potentially at high risk even if her father was not affected. This is because of low probability of males having breast cancer and thus, a woman's father may have escaped the effects of BRCA genes but can pass it on to the daughter. Life style factors such as gaining weight during adult life or excessive alcohol intake increase the risk. The above discussion is not exhaustive but is presented here to illustrate how the algorithm detects those at potentially high risk of breast cancer and presents age and risk appropriate preventive maintenance plan.

Women under 40 years of age do not receive a recommendation for mammograms unless they are flagged as potentially high risk. Those between 40 and 49 years of age receive a brief discussion about optional mammography. While USPSTF does not recommend mammography for this age group, many other groups believe that women age 40-49 should have an option of mammography. The consumer in this age group should have access to information about both options. Women between 50-74 years of age receive standard recommendations for mammography. Women over 75 years of age are advised to consider other health problems they may have, examine their own beliefs and values and discuss their options with their physicians. In addition to mammography advice, all women receive education about monthly self-examination of breast and periodic clinical examination of breast by a physician. Other prevention techniques such as chemoprevention are presented to appropriate groups.

In the breast cancer algorithm, there are five narrative health maintenance documents, each appropriate for age and risk group listed above. For illustration purposes, we present one document (in italics font), which is appropriate for women in 40-49 years of age.

### Breast Cancer Prevention Plan

Cancer Education Message: Cancer may be present without any signs or symptoms. It is desirable to perform screening tests to detect cancer in early stages because if it is present, treatment can be started. With treatment in early stages, your chances of obtaining cure and better quality of life would be improved. Sometimes, the screening test is able to detect an early change in body tissues even before the cancer develops. Some people are afraid of finding out if there is a problem that needs to be fixed. There is no need to fear a screening test; rather it can save your life.
Breast Cancer Education: Breast cancer is among the most common cancers in women, second only to lung cancer. The risk increases after 40 years of age and in women with special situations.
What you can do
Experts (e.g. panels from American College of Surgeons) recommend that you learn how to examine your breast for any lumps. We suggest that you watch a video program for self-examination by clicking on the following link.
http:// . . .
There are some risk factors for breast cancer that you can control and minimize. For example, excessive weight gain during adult life and obesity after menopause (generally around 50 years of age) are associated with increased risk of breast cancer. Therefore, we recommend that you maintain good nutrition and exercise regularly. We suggest you review the section on nutrition, exercise, prevention of obesity and diabetes. Besides reducing risk of breast cancer, by pursuing good nutrition and physical exercise there will be other health related benefits also.
Since excessive alcohol intake increases the risk of breast cancer, it is a good idea to limit alcohol to a modest amount, if you drink at all.
How physicians can help
Your physician will examine your breast during annual visits. This is in addition to daily self-examination you are conducting. In addition, your physician will review your family history and ethnic background as well as other risk factors.
Mammography
Mammogram is a special X-ray of breast to screen for breast cancer. If the mammogram detects a change in the breast tissue, your physician will discuss further tests. Vast majority of women will have a negative mammogram. But if the mammogram and subsequent biopsy (examination of the breast tissue under microscope) detects an early stage breast cancer, it is more likely that the cancer would be treatable.
Since you do not have special situations such as positive family history, some experts do not recommend mammography until 50 years of age. However, many experts recommend that after the age 40 years, you should have an option to have screening X-ray of the breast performed every year or every two years. If the screening test (also called mammogram) detects a change in the breast tissue, your physician will discuss further tests, which may include a biopsy. Vast majority of women will have a negative mammogram. But if the mammogram and subsequent biopsy detects an early stage breast cancer, it is more likely that the cancer would be treatable.
Mammograms are relatively inexpensive. Average cost of mammogram in the United States is about $100 for uninsured women. For insured women, there may be little or no out-of-pocket cost.
Mammogram may result in a “false positive” test. In other words, while the screening test is positive, the biopsy may turn out to be normal. In that case, you would worry about possibly having breast cancer until the biopsy results are available and are found to be normal.
Therefore, we suggest that you should seek the advice of your physician and discuss your own beliefs and values for detection of cancer. Your discussion may focus on chances of detection of early cancer, life years saved and your feelings about undergoing discomfort and anxiety if the screening mammogram was positive and biopsy was negative.
   The checklist associated with above plan is presented below.

### Example B

### Type II Diabetes Prevention

There are 23.6 million people in the United States, or 7.8% of the population, with Diabetes Mellitus. Although diabetes can be controlled and many of its complications prevented, more than 5 million people are undiagnosed. In addition, 57 million have pre-diabetes, in whom elevation in blood glucose is not high enough to diagnose diabetes. If an individual is detected to have pre-diabetes, there are many approaches to prevent or delay the onset of diabetes.

The clinical algorithm determines risks of diabetes in the following way. (1) If the age of the user is 45 years or more, appropriate blood tests are recommended as part of the preventive health maintenance plan (unless the user reports existing diabetes in which case they receive a link to diabetes disease management). (2) Adults younger than 45 years are considered high risk for diabetes if they provide a history of diabetes in the family (parent or sibling), or are overweight (BMI greater than 25), report African American, Alaska Native or American Indian, Pacific Islander, Asian American, or Hispanic ancestry, have given birth to a baby weighing more than 9 pounds or had diabetes during pregnancy, and report having high blood pressure. (3) Adults who report sedentary life style also receive preventive health maintenance plan for diabetes.

The preventive health maintenance plan includes fasting blood glucose or glucose tolerance test, and blood lipids (cholesterol, high density and low density cholesterol and triglycerides). If their BMI is greater than 25, and especially if it is greater than 30, they receive extensive information about diet and exercise and motivational support through reminders and further education. Links to resources for behavioral modification are provided. Finally, the individual at high risk are informed about chemo-prevention (Metformin) and receive a suggestion to consult his or her physician to determine appropriateness of chemoprevention.

As illustrated in the breast cancer prevention example, information and health maintenance plans is presented in non-technical and consumer friendly fashion. An age and risk group appropriate, narrative plan is followed by a checklist of steps and time line to assist the individual to track progress in implementation of the plan. Reminders, further education and support are offered to encourage completion of the health maintenance plan.

### Example C

### Sickle Cell Disease and Trait

This example is chosen to illustrate how the clinical algorithm utilizes race and ethnicity, newborn screening and genetic counseling of individuals in childbearing age to present an appropriate preventive plans for a common genetic disease in African American population. Sickle Cell Disease, a painful condition with many complications and a potential for early death, is caused by an inherited abnormality of hemoglobin. One in 12 African Americans carries a trait (a recessive gene). Although they are generally asymptomatic, they have 25% chance to have a child with sickle cell disease if the other parent also has a trait.

The clinical algorithm for sickle cell disease in the system comes into play in two different ways; for a newborn user or a user in childbearing age. If the preventive plan is being prepared for a newborn user (obviously by a parent), the parent is asked to inquire about the outcome of the newborn screening test for Sickle Cell Disease (Hb SS and other variants) and other hemoglobinopathies, performed universally in all newly born infants in the United States If the newborn is positive for Sickle Cell Disease, the parent receives a disease management link and critical information about (1) penicillin prophylaxis and pneumococcal vaccines to prevent serious and potentially fatal infections from S. pneumoniae, (2) information about other preventable complications such as splenic sequestration crisis and education about prevention of such episodes, and (3) information about Transcranial Doppler to predict risks for stroke, a disabling and potentially fatal complication of sickle cell disease in children. Further, they are advised to seek genetic counseling for themselves and their family members.

If the user is an adult who checks African American ancestry, family history and advanced questions include inquiry about results of sickle cell screening tests. The preventive health maintenance plan for all African Americans includes education, screening and genetic counseling for Sickle Cell Disease and trait, unless they already know their status. Educational section includes information about options available to individuals with sickle cell trait; testing of significant other and family members for sickle cell trait; reproductive options, prenatal diagnosis, and current state-of-the-art in cure (through cord blood stem cells or bone marrow transplant) and prevention of sickle cell disease. Information is presented in a non-directional, non judgmental and ethical fashion so that the consumers are able to make informed choices based on their own values and beliefs.

### FIG. 5: System Description

To illustrate an embodiment, not to be construed as limiting, we present an experience of a user as he or she navigates through the system.

FIG. 5 (a1) & FIG. 5 (a2): Brief Introduction, Registration & Login
The user receives introductory information about the purpose of the application, registration and password protection, user agreement and informed consent. User is able to proceed only if he or she signs the user agreement and informed consent. The user is authenticated through a unique login and password. The security of the system ensures that the user is bonafide and a ghosted machine is not able to create an account. We use systems similar to banks and other financial institutions to provide the user a secure way to communicate personal information such as name, age or birth date, sex, race, geographic location, height, weight, current or past illnesses, family history, laboratory values and other medical information covered under the Health Insurance Portability and Accountability Act (HIPAA) and other relevant statutes.

FIG. 5 (b): User Agreement and Consent
Once the user is successfully authenticated and gains access to the system, he or she agrees to terms of usage confirming their understanding that the use of the system does not establish a doctor-patient relationship with physicians advising or assisting administrators of the automated system. They understand that the sole purpose of the system is to provide education about health promotion. They would not hold system responsible for illnesses that they may suffer from, failure to detect illnesses, or treatment of illnesses since the system does not attempt to provide diagnostic or therapeutic health care. They understand that participation in the system may cause anxiety or stress and is entirely voluntary.

FIG. 5 (c): Questions to Elicit Initial Information
The software system classifies the individual into various groups. Since the illustration in this Figure is an example of breast cancer prevention system, if the subscriber is a male, this algorithm stops. (There will be other applicable algorithms for males and for both sexes in the system.) If the subscriber is a female, the system classifies the individual in one of the following groups:
Age less than 40 years
Age 40-49 years
Age 50-74 years
Age greater than 75 years
In subsequent steps, the system classifies the first group (age less than 40 years) into one of the two subgroups; regular risk and high risk.
The system also calculates BMI and classifies the individual into two groups; those over BMI of 25 and those under 25.

FIG. 5(d): Past and Current Illnesses
The purpose of questions in this screen is to elicit any current or past illnesses so that an inappropriate prevention plan is not presented. The system does not provide prevention plan for an illness that has already occurred. Instead, it refers the user for management of that disease to an appropriate link (e.g. a list of specialized centers in the United States or a specific region). Therefore, if the user answers yes to Cancer and then, yes to Breast Cancer, she is referred to Breast Cancer Disease Management Link and not be presented with a breast cancer prevention plan.

FIG. 5(e): Family History
For breast cancer (as an example), the algorithm detects following pattern:
   The system classifies the individual as regular risk for breast cancer if there is no family history of breast or ovarian cancer.
   If the individual has not answered family history questions, the system classifies the individual as regular risk (by default). However, if the individual returns to the system and revises the family history, the system is capable of re-classifying the risk status.
   The system classifies the individual as potentially high risk if
      There is history of breast or ovarian cancer in parents, brother or sister, son or daughter (first degree relative).
      If the individual has Ashkenazi Jewish ethnicity (Step II) and has any family history (first or second degree relative) with breast or ovarian cancer, the system will classify the individual as potentially high risk.
      If there is history of paternal grandmother and paternal aunt with breast cancer, the pattern will be recognized as potentially high risk even if father had no history of breast cancer. This is because breast cancer genes could be inherited through father who, as a male, would have low probability of expression of breast cancer genes.

FIG. 5(f): Advanced Questions
If the system has classified the individual as potentially high risk for breast cancer, the individual is presented with following question.
A brief explanation of what breast cancer genes are is provided (BRCA1 and BRCA2 genes). The question is not asked if the subscriber is classified as regular risk.

Comprehensive Analysis
The system currently classifies the individual in one of the following groups.
   1. Female 30-40 years of age; regular risk
   2. Female 30-40 years of age; high risk
   3. Female 40-49 years of age
   4. Female 51-74 years of age
   5. Female greater than 75 years of age

FIG. 5 (g): Summary and Confirmation
Please review the information recorded in the system for accuracy:
If incorrect is checked, the system provides an opportunity to edit information in previous steps.

FIG. 5 (h): Individualized Health Maintenance/Prevention Plan
The system matches each group with an appropriate prevention document.
   1. Female under 40 years of age; regular risk
   2. Female under 40 years of age; high risk
   3. Female 40-49 years of age
   4. Female 51-74 years of age
   5. Female greater than 75 years of age

FIG. 5 (i): Individualized Health Maintenance/Prevention Checklist
The system matches each group with an appropriate checklist document.

FIG. 5 (j): Educational Programs
Subscribers receive links to relevant health education content; e.g. all female subscribers who receive breast cancer prevention plans are provided a link to education about self-examination of breast. Another example: for prevention of certain infectious diseases, a video of hand washing techniques will be available.
The user is able to update the checklist for completion of recommended actions. For example, when the subscriber has seen the video for self-examination of breast or made an appointment with a physician or scheduled a mammogram, she can check the completion of the action on the checklist.

FIG. 5 (k): Reminders
The system sends reminders of incomplete actions based on time line provided in the checklist.

Consumer Feedback and Plan Effectiveness
The system collects feedback information from the consumer about reading and comprehension, perceptions and feelings, and their unmet needs. If consumers are not able to complete recommended steps, the system develops ways to enhance communication, education, support and encouragement to elicit improved compliance. Also, if scientific advances occur, e.g. discovery of additional breast cancer genes, the plan will be modified accordingly.

Periodic Update of Algorithm
The algorithm is updated periodically based on consumer feedback and plan effectiveness evaluations.

FIG. 6: Technical Architecture & Considerations

As shown in FIG. 6 (a), the consumer uses the system on the regular web site as well as social network on the Internet. As mentioned above, the social networking site may already have information about the individual that can be used to populate the System. Also, in another embodiment, if the social network has a physician-specific group, the patient interaction may allow interaction with that physician's office.

As shown in FIG. 6 (b), the user may use the System on a SmartPhone or PDA device. The Operating System of the device allows the event queue to access the System and the database.

### Our Current Selected Technology Stack

Front End: PHP 5.x, XHTML, CSS
Database: MySQL 5.x
Browser Compatibility: IE 7.0, 8.0 and Firefox Mozilla 3.0, 3.5
Screen Resolution: 1024×768

### Technology Platform Considerations

PHP is the most popular web scripting language and a widely used programming language used for Application development using Zend Framework. PHP is an open source technology and can be easily deployed without any licensing fees, the savings resulting from which makes it possible to reach a larger size of the public cost effectively.
User Friendly: Simple and easy to learn compared to other programming languages such as C, C++, ASP or ASP.net.
Architecture: The application is developed on Zend Framework which is a secured, reliable and according to Web 2.0 standards
Web service Integration: The framework supports web services development and integration that would be further used during the mobile phone portability.
Versatile: The system is deployed on most of the web servers and runs on all major operating systems like Mac OS, Windows and Linux.
Free From Restrictive Licenses: There are no restrictive licensing involved compared to other proprietary languages like Java and ASP.NET.
Drastic Reduction in Server Cost: PHP is designed to run on Linux and Apache, which are both open source software and have zero upfront costs and ongoing costs getting future updates freely helping entrepreneurs to save on their server maintenance cost compared to Windows servers which include on-going maintenance and upgrade costs.
Mature Code: Being developed on Zend Framework, the development is done based on the proven standards so less time consuming for other developers to debug compared to other proprietary software like ASP.NET, JAVA
Robustness/Reliability: Apache/PHP is significantly more stable than IIS/ASP, providing better uptime.
Convenient Debugging: Facilitates built-in debugger which allows finding bugs more quickly and getting detailed information about the error during the development.

### Other Considerations for Technology Selection

The total cost of ownership of PHP is less as compared to .NET and Java when considering development and the procuring costs of licensed editions.
Lower initial costs for implementation, while ensuring reusability of developed software for enhancements and integrations.
High skill availability of the underlying technology.

### Additional Embodiments

In another embodiment, if the reminder option is available from the patient's physician or the provider system and is activated, the consumer may receive reminders through text messages or emails from the provider.

In another embodiment, as the specific information for a patient is analyzed and a personalized health maintenance plan is delivered, the system is also designed to allow the patient to review, print and even export their health maintenance plan as an electronic document or to an email address or if allowed by their physician/health insurance company to import into their electronic health record or to their personal health record.

In an additional embodiment, the System is able to extract information from the Electronic Medical Record and update the completion of various steps of the plan, while maintaining confidentiality and compliance with relevant laws.

The user is able to print the information or export it to another site, e.g. personal computer or a primary care provider's office computer if such exchange is allowed by the receiving device.

Although the description above contains much specificity, these should not be construed as limiting the scope of the invention but as merely providing illustrations of some of the presently considered embodiments of this invention. For example, recommendations of the expert panels may use qualifiers other than those mentioned above, such as geographic location or travel to a different geographic location (which exposes the individual to a different environment). Another example of broader application is to allow multiple users within the same family or group to create profiles on a single system and generate plans for each individual.

We claim:

1. A health maintenance method that comprises:
making a questionnaire available to nominally healthy individuals, wherein the questionnaire elicits from each individual responding to the questionnaire information regarding that individual's risk factors for a plurality of medical conditions, said information including race/ethnicity and family history to detect genetic susceptibility;
processing questionnaire responses to generate individualized health maintenance plans having actions to be taken by the individual to reduce that individual's risk from at least one of said medical conditions, wherein at least one of the actions requires more than consulting with a doctor about a specified topic; and
providing individuals who have responded to the questionnaire with their individualized health maintenance plans.

2. The method of claim 1, wherein the plurality of medical conditions includes at least one form of cancer and heart disease.

3. The method of claim 1, wherein the plurality of medical conditions includes cancers of various organs, heart disease, high blood pressure, emphysema and chronic lung disease, nutritional disorders, obesity and diabetes, genetic conditions for which newborn screening and preventive plans are available, infectious diseases, mental health and behavioral disorders, arthritis and musculoskeletal disorders, and preventable injuries.

4. The method of claim 1, further comprising:
providing at least some of the individuals who have responded to the questionnaire with one or more follow-up messages to remind or encourage them to act in accordance with their individualized health maintenance plans.

5. The method of claim 1, further comprising:
receiving action completion information for an individual; and
updating that individual's health maintenance plans to show that one or more of the actions in the plan have been completed.

6. The method of claim 5, wherein said receiving includes periodically retrieving that individual's electronic medical record to monitor any changes.

7. The method of claim 5, wherein said updating further includes adding to that individual's health maintenance plan a new action to be taken by the individual based on the completion information.

8. The method of claim 1, wherein at least some of the individualized health maintenance plans include optional or alternative actions.

9. The method of claim 8, wherein the individualized health maintenance plans include estimated cost information for at least any actions that are optional or alternative actions.

10. The method of claim 1, wherein the individualized health maintenance plans are in checklist form.

11. A health maintenance system that comprises:
a computer network having one or more servers executing health maintenance service software that causes the one or more servers to effect a method that includes:
making a questionnaire available to nominally healthy individuals, wherein the questionnaire elicits from each individual responding to the questionnaire information regarding that individual's risk factors for a plurality of medical conditions that include heart disease and at least one form of cancer, wherein said information includes at least family history and race/ethnicity; and
providing individuals who have responded to the questionnaire with individualized health maintenance plans having actions to be taken by the individual to reduce that individual's risk from at least one of said medical conditions.

12. The system of claim 11, wherein at least one of the actions does not require a consultation with a clinician.

13. The system of claim 11, wherein the plurality of medical conditions includes cancers of various organs, heart disease, high blood pressure, emphysema and chronic lung disease, nutritional disorders, obesity and diabetes, genetic conditions for which newborn screening and preventive plans are available, infectious diseases, mental health and behavioral disorders, arthritis and musculoskeletal disorders, and preventable injuries.

14. The system of claim 11, wherein the method effected by the one or more servers further includes:
providing at least some of the individuals who have responded to the questionnaire with follow-up messages to remind or encourage them to act in accordance with their individualized health maintenance plans.

15. The system of claim 11, wherein the method effected by the one or more servers further includes:
receiving action completion information for an individual; and
updating that individual's health maintenance plans to show that one or more of the actions in the plan have been completed.

16. A health maintenance method that comprises:
completing, via a computer network, a questionnaire that elicits information regarding risk factors for a plurality of medical conditions including at least one form of cancer and heart disease, wherein said information includes race/ethnicity and family history to detect genetic susceptibility; and
receiving a personalized health maintenance plan having actions to be taken to reduce risk from those medical conditions for which elevated risk factors have been identified.

17. The method of claim 16, wherein at least one of the actions does not require a consultation with a clinician.

18. The method of claim 17, wherein the plurality of medical conditions includes cancers of various organs, heart disease, high blood pressure, emphysema and chronic lung disease, nutritional disorders, obesity and diabetes, genetic conditions for which newborn screening and preventive plans are available, infectious diseases, mental health and behavioral disorders, arthritis and musculoskeletal disorders, and preventable injuries.

19. The method of claim 16, wherein said completing includes accessing the computer network via an Internet-enabled wireless device.

20. The method of claim 16, wherein said completing includes authorizing retrieval of personal information from a social networking service.

21. The method of claim 16, further comprising:
receiving a reminder message to act in accordance with the personalized health maintenance plan.

22. The method of claim 21, wherein the reminder message is an email, instant message, text message, or message communication via a social networking service.

23. The method of claim 16, further comprising:
receiving an updated health maintenance plan after completing at least one action in the personalized maintenance plan.

24. The method of claim 16, wherein the questionnaire includes questions on age, gender, race/ethnicity, lifestyle, individual history, family history, and geographic location.

25. The method of claim 16, wherein the information includes results of a genetic screening test.
